(19) United States
(12) Patent Application Publication
(10) Pub. No.: US 2021/0089924 A1
(43) Pub. Date: Mar. 25, 2021

(54) LEARNING WEIGHTED-AVERAGE NEIGHBOR EMBEDDINGS

(71) Applicant: NEC Laboratories America, Inc., Princeton, NJ (US)

(72) Inventors: Erik KRUUS, Hillsborough, NJ (US); Christopher MALON, Fort Lee, NJ (US); Bingyuan LIU, State College, PA (US)

(73) Assignee: NEC LABORATORIES AMERICA, INC, Princeton, NJ (US)

(21) Appl. No.: 17/030,299

(22) Filed: Sep. 23, 2020

Related U.S. Application Data
(60) Provisional application No. 62/904,737, filed on Sep. 24, 2019.

(51) Int. Cl. G06N 3/08; G06N 3/04

(52) U.S. Cl. CPC G06N 3/084; G06N 3/04

(57) ABSTRACT

Aspects of the present disclosure describe improving neural network robustness through neighborhood preserving layers and learning weighted-average neighbor embeddings.

### CROSS REFERENCE

This disclosure claims the benefit of U.S. Provisional Patent Application Ser. No. 62/904,737 filed Sep. 24, 2019 the entire contents of which is incorporated by reference as if set forth at length herein.

### TECHNICAL FIELD

This disclosure relates generally to neural network training and more particularly to learning techniques employing learning weighted-average neighbor embeddings.

### BACKGROUND

Those skilled in the art will understand and appreciate that it is common to encounter complex input graphs where nearest neighbor edges support a local distance concept and lie within some input manifold. Oftentimes, graph nodes lie in a true vector space equipped with a metric (ex. L2 distance), while other input graphs only approximately form a manifold (i.e. distances may not be defined between all points, or triangle inequality may sometimes be violated). Also common are situations where an input graph (or points in a vector space) are time-dependent. For example, raw observations may change in nature over time, or input points may be functional outputs where parameters of the function are changing (e.g. layer outputs of a neural network during training).

As those skilled in the art further understand, the problem is to find an embedding of such input in a low-dimensional space where: local structure in the input manifold is reflected in the low-dimensional space including desirable smoothness guarantees; and input may be time-dependent or provided online fashion.

To construct a dimension reducing mapping, a common method uses neural network layer[s], characterized by an abundance of network parameters. However, such mappings (e.g. fully connected or convolutional layers) are prone to learning non-smooth functions that are susceptible to adversarial attack.

To partially alleviate non-smoothness, problem-specific regularizations and adversarial training are oftentimes employed. These layers are easily trained via gradient backpropagation and generally solve for time-dependent or online input but not smoothness.

Other techniques (such as t-SNE or UMAP or other nearest-neighbor based smoothings) are constructed so as to learn smoother mappings wherein dimension reduction accurately reflects the manifold structure of the input graph. The manifold representations we target (e.g. UMAP) use particular weightings of nearest neighbor information, gleaned from a list of correspondences between points in input and output spaces. In particular, the mappings adapt locally to the local intrinsic dimension. However, their current capability is limited to embedding a pre-existing dataset, so these embedding methods are not trainable, and not online. They are not online, because they typically determine one low-dimensional point for every input example.

### SUMMARY

The above problems are solved and an advance in the art is made according to aspects of the present disclosure by adapting certain manifold representation techniques to an online setting that advantageously affords practical real world benefits including uses in machine learning applications for training neural networks in applications desiring dimension reduction, interpretability, smoothness, and acting as a form of regularization providing benefit against adversarial attack. In addition, our disclosed techniques advantageously extends static dimensional reductions (i.e. developed after a network is trained) to be treated as full-fledged, parameterized network layers that adapt along with other network layers to incoming data during the training process.

According to aspects of the present disclosure, we employ a particularly useful manifold embedding technique (UMAP) and demonstrate that it can be fully trained along with a neural network. Advantageously, this allows same to be placed as internal (non-final) layers in a neural network and trained.

As we shall show and describe further, our inventive approach extends nearest neighbor-based dimension reductions that adapt to the manifold of the input data to handle new or changing input data. One most important addition is to support gradient back-propagation to such layers and advantageously solves the above-mentioned problems—providing an alternative or adjunct to existing smoothness-inducing techniques.

Still further, when graph inputs change, we may update embedding in two ways: (i) we can add inputs far from currently stored node embeddings; and (ii) we add gradient backpropagation so existing mapping information can be updated.

As those skilled in the art will appreciate, our method(s) allow the creation of a network layer that can operate on raw inputs, or on outputs of previous network layers.

In one embodiment, we choose the UMAP algorithm and describe how to construct and train a manifold-reproducing network layer with much-improved adversarial robustness when compared with a trained, fully-connected layer. We further describe how a potentially infinite amount of input data can be used to train such a mapping within a bounded amount of memory, by introducing a merge operation between two mappings, such as one mapping for older data, and one mapping for more recently seen data.

To maintain a finite-memory “cloud” of online correspondences describing the input and output manifolds we introduce an age factor and a summarization factor that allows a static manifold representation to be extended to a dynamic situation, such as training a neural network which includes a manifold representation layer as part of its calculations.

### BRIEF DESCRIPTION OF THE DRAWING

A more complete understanding of the present disclosure may be realized by reference to the accompanying drawing in which:

FIG. 1 is a schematic diagram illustrating existing neighbor-based embedding according to aspects of the present disclosure;

FIG. 2 is a schematic diagram illustrating the embedding of a new point by existing methods according to aspects of the present disclosure;

FIG. 3 is a schematic diagram illustrating mapping data by existing methods according to aspects of the present disclosure;

FIG. 4 is a schematic diagram illustrating the training of an embedding layer within a neural network by our inventive method according to aspects of the present disclosure;

FIG. 5 is a schematic diagram illustrating the training of an embedding layer according to aspects of the present disclosure;

FIG. 6 is a schematic diagram illustrating online streaming data training according to aspects of the present disclosure;

FIG. 7 is a schematic diagram illustrating an example of a simplicial complex according to aspects of the present disclosure;

FIG. 8 is a schematic diagram illustrating an example of degenerated simplex according to aspects of the present disclosure;

FIG. 9 is a schematic diagram illustrating a Delta complex as a functorial image of delta according to aspects of the present disclosure;

FIG. 10 is a weighted UMAP plot according to aspects of the present disclosure;

FIG. 11 is an unweighted UMAP plot according to aspects of the present disclosure;

FIG. 12 is a schematic diagram showing an illustrative network structure with UMAP according to aspects of the present disclosure;

FIG. 13 is a 12 points data plot according to aspects of the present disclosure;

FIG. 14 is a 12 points embedding plot according to aspects of the present disclosure;

FIG. 15 shows an illustrative defined UMAP layer according to aspects of the present disclosure;

FIG. 16 shows a plot illustrating a realization of 2-D embedding after training according to aspects of the present disclosure;

FIG. 17 shows a plot illustrating embedding before training according to aspects of the present disclosure;

FIG. 18 shows a plot illustrating embedding after training according to aspects of the present disclosure;

FIG. 19 is a schematic diagram illustrating updating embedding with a pretrained network according to aspects of the present disclosure;

FIG. 20(A) and FIG. 20 (B) are plots showing FIG. 20 (A) training embedding (2000) points; and FIG. 20(B) testing embedding (1000) points according to aspects of the present disclosure;

FIG. 21 shows a plot of training embedding (new arch) according to aspects of the present disclosure;

FIG. 22 is a schematic diagram illustrating a new network architecture according to aspects of the present disclosure;

FIG. 23(A) and FIG. 23 (B) are plots showing comparisons of low embeddings (no regularization) in which FIG. 23 (A) training embedding using network; and FIG. 23(B) training embedding using UMAP—according to aspects of the present disclosure;

FIG. 24(A) and FIG. 24 (B) are plots showing comparisons of low embeddings (with regularization) in which FIG. 24 (A) training embedding using network; and FIG. 24(B) training embedding using UMAP—according to aspects of the present disclosure;

FIG. 25 is a plot showing batch learning results (50 epochs) for testing set embedding—according to aspects of the present disclosure;

FIG. 26(A) and FIG. 26 (B) are plots showing comparisons of batch learning with deeper layers (50 epochs) in which FIG. 26 (A) training set embedding; and FIG. 26(B) testing set embedding—according to aspects of the present disclosure;

FIG. 27 is a schematic diagram illustrating an adversarial attack framework architecture according to aspects of the present disclosure; and

FIG. 28 is a plot showing testing accuracy over PGD attack according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

As noted above, particularly inventive features according to aspects of the present disclosure that advantageously contribute to solving the above-noted problems include:

Backpropagating gradients from a neighborhood matching loss function to govern how points in high-dimensional input space are updated;

Maintaining a dynamic finite-memory mapping summarizing how the manifold representation technique maps points between an input space and output space and maintains nearest neighbor information:

An age factor is introduced which affects how nearest-neighbor weighted averages are calculated in both input and output spaces, such that newer information is more important than historical information about the mapping. It is permitted to delete points based solely on age factor being low/lowest.

Representing the mapping in finite memory is also helped by a summarization operation that allows summarizing entries from one or more sets of mappings into one, such that the total number of mapping entries remains bounded. In practice, this uses a “merge” operation that absorbs information from a “newer” nearest-neighbor data structure into an “older” nearest-neighbor data structure. A summarization weight is also introduced. After a summarization, nearest-neighbor weighted averages reflect, in addition to age, a summarization weight, wherein the sum of summarization weights is conserved whenever n (2) close mapping are replaced by fewer (1) entries. Mapping summarizations must occur if memory bounds are exceeding. It is possible that smaller problems be solved without summarizations.

Our inventive techniques include a combination of gradient backpropagation of a neighborhood matching loss function of a manifold representation method and a way to effectively maintain nearest neighbor information in an online fashion. With these components, parameters of a dimension-reducing manifold representation technique can be optimized along with more conventional surrounding layers of a neural network.

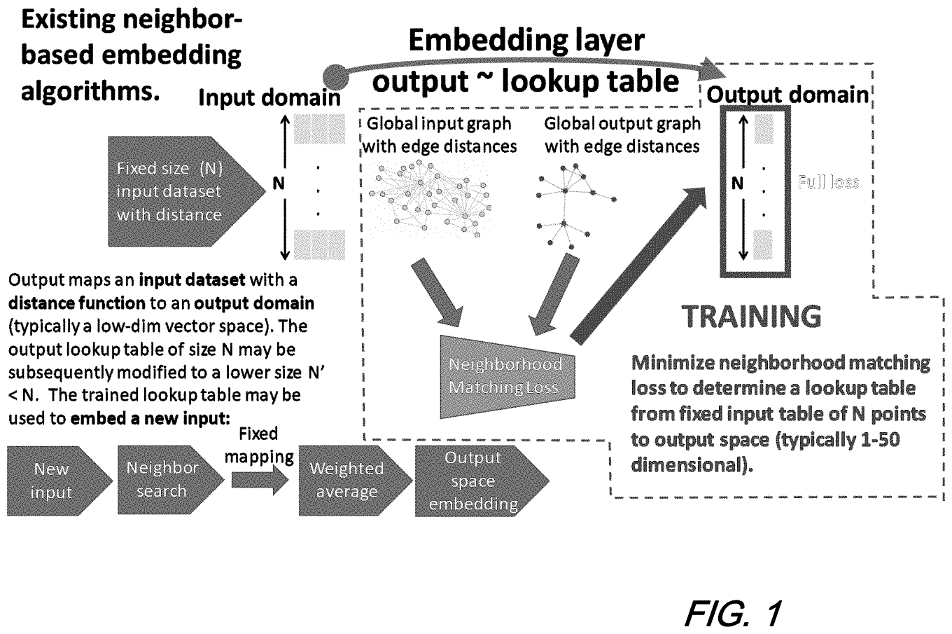

FIG. 1 is a schematic diagram illustrating existing neighbor-based embedding according to aspects of the present disclosure. With reference to that figure it may be observed that an existing neighbor-based embedding algorithm generally takes as input a fixed size input dataset with distance and produces an embedding layer output lookup table wherein a global input graph with edge distances and a global output graph with edge distances undergo neighborhood matching loss. Training generally involves the minimization of neighborhood matching loss to determine a lookup table from fixed input table of N points to an output space—typically 1-50 dimensional. As such the output maps an input dataset with a distance function to an output domain—typically a low-dimensional vector space. The output lookup table of size N may be subsequently modified to a lower size N′<N. and the trained lookup table may be used to embed a new input. Overall, a new input undergoes a neighbor search, a fixed mapping produces a weighted average and output space embedding.

At this point it is useful to introduce any terminology we use herein. More specifically, an input domain is defined by arbitrary node attributes, distance function preferably a metric, but could be a pseudo-metric (ex. triangle inequality may not always hold. Missing edges may be assigned zero weight (equiv. infinite distance) if convenient. It is easily applied to vector inputs including infinite dimensional. Note that in some cases, we add node attributes to include sample weight—used for when points merged—or sample age—used with time-dependent input distributions. While input dimension may be high or infinite, local and global intrinsic dimension should remain bounded for local embedding concepts to apply.

The output domain is a low-dimensional metric space—ideally O—intrinsic dimension. It may include additional regularization terms in some applications.

Training is typically stochastic gradient descent (SGD) via backpropagation, and neighborhood matching loss typically based on cross entropy.

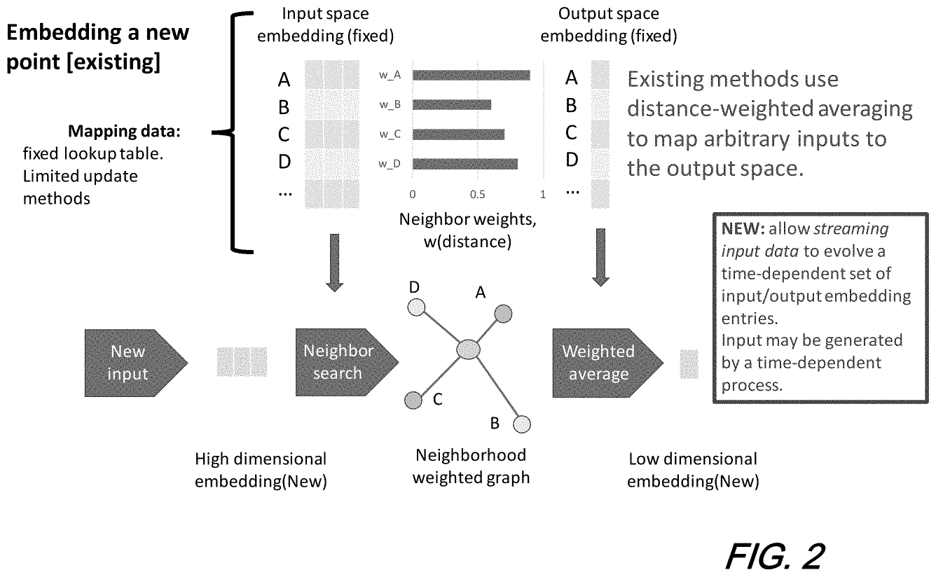

FIG. 2 is a schematic diagram illustrating the embedding of a new point by existing methods according to aspects of the present disclosure. As shown in that figure, embedding a new point by existing methods includes mapping data employing a fixed lookup table with limited update methods. As such input space embedding is fixed and output space embedding is fixed and such methods use distance-weighted averaging to map arbitrary inputs to the output space.

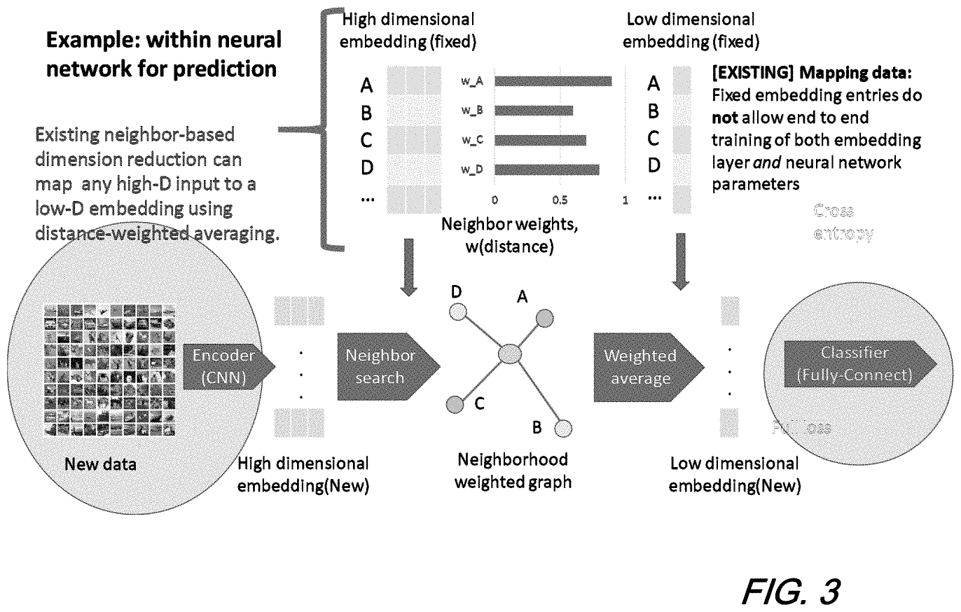

FIG. 3 is a schematic diagram illustrating mapping data by existing methods according to aspects of the present disclosure. As shown, existing neighbor-based dimension reduction can may any high-D input to a low-D embedding using distance-weighted averaging. As such, existing mapping data using fixed embedding entries do not allow end to end training of both embedding layer and neural network parameters.

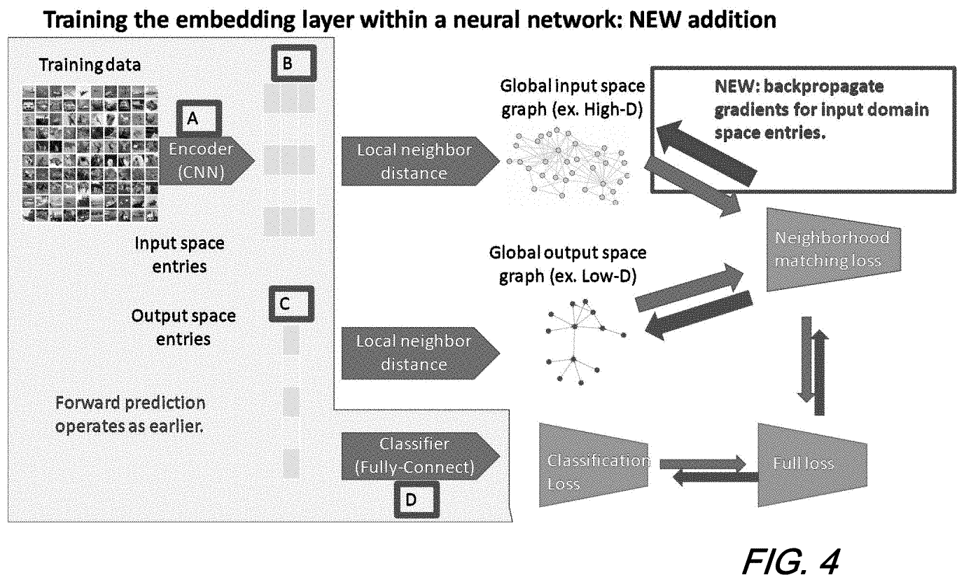

FIG. 4 is a schematic diagram illustrating the training of an embedding layer within a neural network by our inventive method according to aspects of the present disclosure. Shown in that figure is that methods of the present invention advantageously backpropagate gradients for input domain space entries.

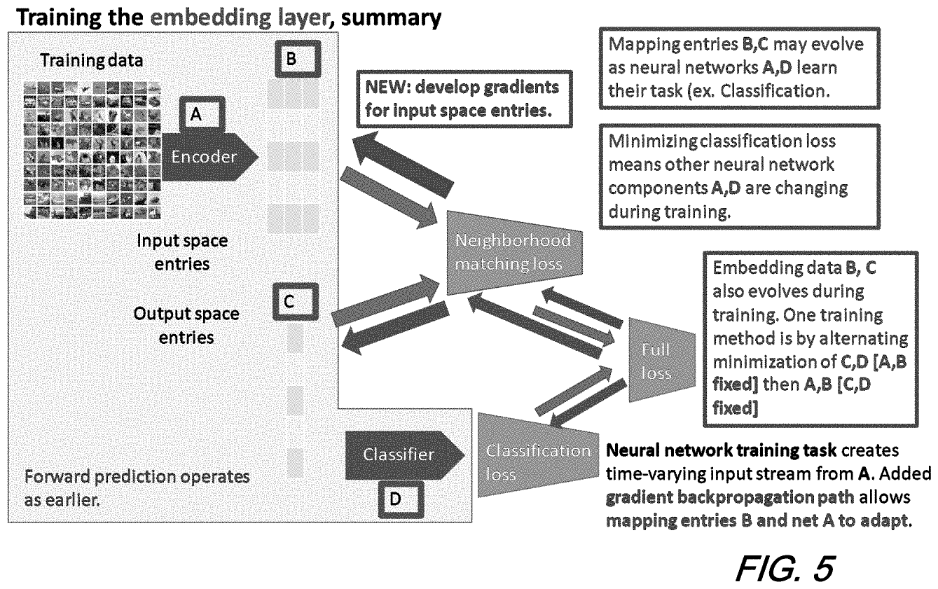

FIG. 5 is a schematic diagram illustrating the training of an embedding layer according to aspects of the present disclosure. As shown, we develop gradients for input space entries. Mapping entries shown as B, C may evolve as neural networks A, D learn their task (ex. Classification). Minimizing classification loss means that other neural network components A, D are changing during training. Embedding data B, C also evolves during training. One illustrative training method involve alternating minimization of C, D [A, B fixed] then A, B [C, D fixed]. Accordingly, our neural network training task creates a time-varying input stream from A. Our inventive added gradient backpropagation path allows mapping entries B and net A to adapt.

At this point we again note that with respect to backpropagation, input domain updates—various methods have been tried. More specifically, exact gradient, sample point and all input space neighbors all change. Such an approach provided full loss backpropagating into both embedding and neural net layers and sometimes had stability issues and was slower than alternative approaches.

When a gradient update was applied to fewer points—especially for fixed-size data set—only modify points of the minibatch themselves, leaving neighbor entries unchanged.

For streaming data—pre-existing points only age—no gradient update. New data continually adds into a new neighbor data structure that periodically is merged into the aging data structure.

Finally, we note that alternating minimization stabilizes the training procedure, because classifier and encoder updates are separated.

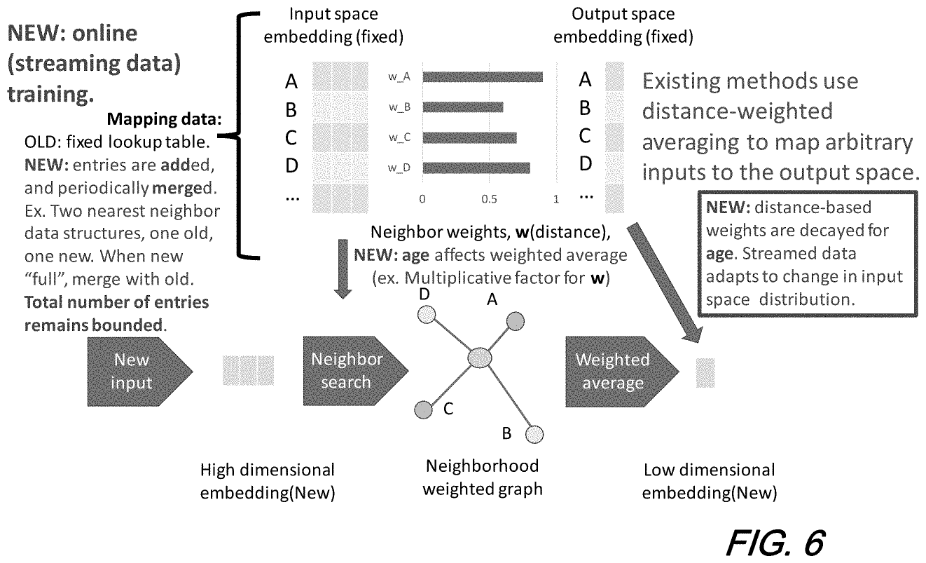

FIG. 6 is a schematic diagram illustrating online streaming data training according to aspects of the present disclosure. In contrast to old methods employing a fixed lookup table, with our inventive method entries are added and periodically merged. By way of example, two nearest neighbor data structures, one old, one new. When new full, merge with old. The total number of entries remains bounded. Additionally, as noted in that figure, our new distance-based weights are decayed for age. Streamed data adapts to change in input space distribution.

With respect to data structures, embedding entries generally (sample weight, sample age, input domain entry, output space vector)=(S, A, I, O). Input domain entries can be restricted to the subset of input domain attributes required for calculating distance function. Embedding entries generalize to include sample weight, and age weight. Note that age and sample weight may be combined in practice, other node attributes may be used within the distance function and usual output domain is a metric space. Sample and age weights operate multiplicatively with the distance-based weighting and final weights are normalized to form a weighted average of output space entries. data structure supporting fast nearest neighbor operations is preferred including add (point) and del (point).

Our inventive methods add a merge operation that takes two {(S, A, I, O)} nearest neighbor data structures and reduces the total number of entries. Both top-down (greedy furthest) or bottom-up (clustering) approaches) wherein clustering method is also class-aware and should advantageously handle unlabeled data.

At this point, we now describe a new neighborhood preserving layer which can advantageously replace a fully connected layer and improve the network robustness, taking maximum advantage of a UMAP algorithm.

First, we describe the mathematical intuition of UMAP. Next, describe how UMAP can be adapted to online fashion. We then describe the introduction of UMAP itself as a layer to achieve dimension reduction. Finally, describe a neighborhood preserving layer, which is based on UMAP or other neighborhood graph. We show that the model can be trained efficiently and improve the robustness theoretically and empirically.

How UMAP Works

In short, UMAP assumes there is a low-dimensional embedding such that all data points are uniformly distributed in this embedding and that we can extract a topology structure of an original, high-dimensional space and its low dimensional embedding through a local fuzzy set. In this way, we can find an “optimized” embedding that minimizes any difference between two local fuzzy sets. Stated alternatively, the embedding extracts most of the information of original data.

Manifold and KNN

We start with the manifold assumption. Uniform assumption and Lemma 1 indicates the following:

Statement: Any ball B centered at arbitrary point X that contains exactly k-nearest-neighbors should have fixed volume regardless of the choice of Xᵢ∈X This statement motivates us to use the KNN to construct the local fuzzy sets. Since the k-nearest neighbor always contains same amount of information, it is reasonable to construct a topological structure from the distance calculated from KNN. The key part will be how to construct local fuzzy simplicial set out of KNN information.

Simplicial Complex and Simplicial Sets

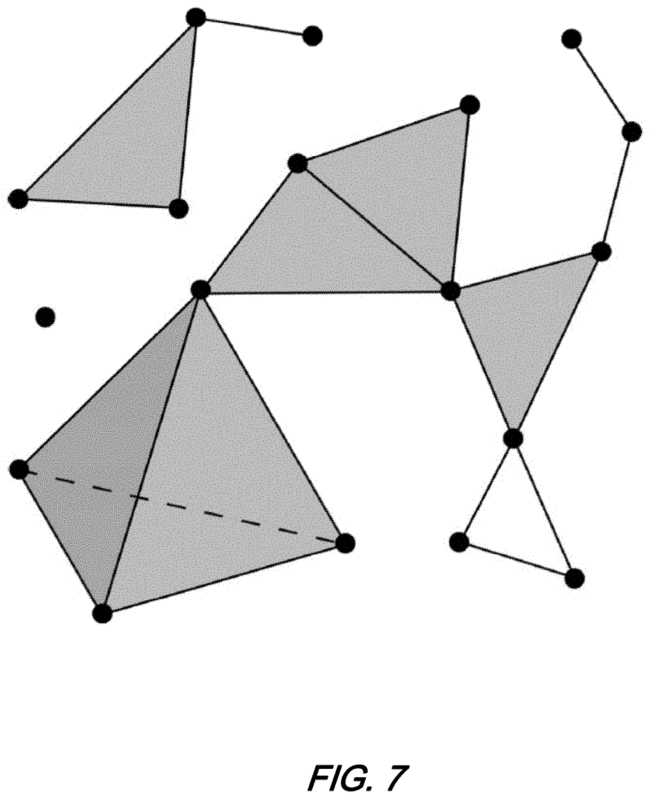

To understand how topology helps us extract the data pattern, we start with a look at simplicial complex, with an example illustratively shown in FIG. 7. We can simply regard it as “gluing together” multi 0, 1, 2, 3, . . . -simplices.

The simplices uniquely determine connectivity between data points. However, a simplicial complex still stores some redundant information in an aspect of topology, such as the exact location of vertices and length of edges. Thus, we wish to introduce a definition of a simplicial set, in which we only carry the connectivity information (i.e., who is connected with who).

As we shall show, this can be defined formally using category theory. If we define category A to be objects the finite order sets [n]={1, . . . , n}, with morphims given by order-preserving maps. Then simplicial set is defined as the functor:

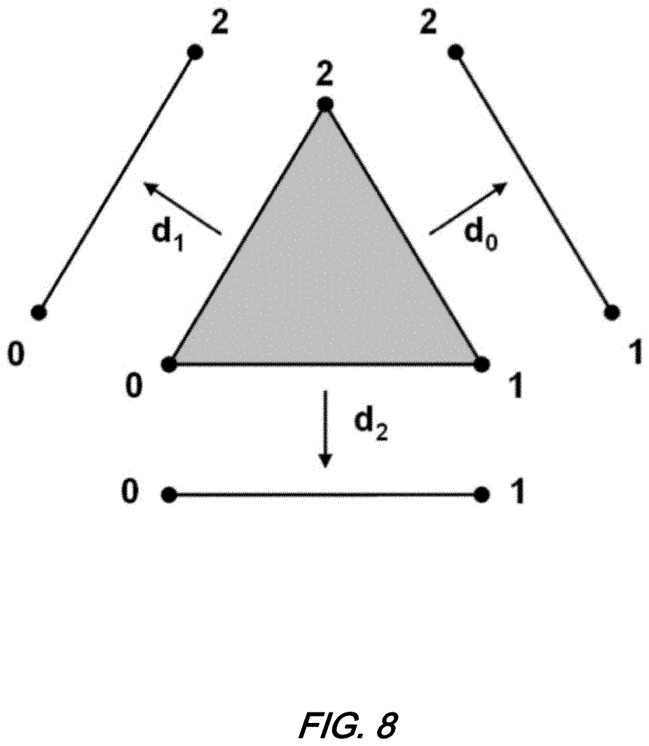

Definition 1 A simplicial set is a functor from Δ^{op}→Sets, the category of sets. In A, we include all the kinds of simplices and its degenerated version. For example, {0,1,2} represents a 2-simplex(triangle), and {0,0,2} represented a specific edge of this 2-simplex (See FIG. 8). This degeneration can be achieved through face maps, and the defined functors help us mapping these basic elements to a simplicial complex of our interest.

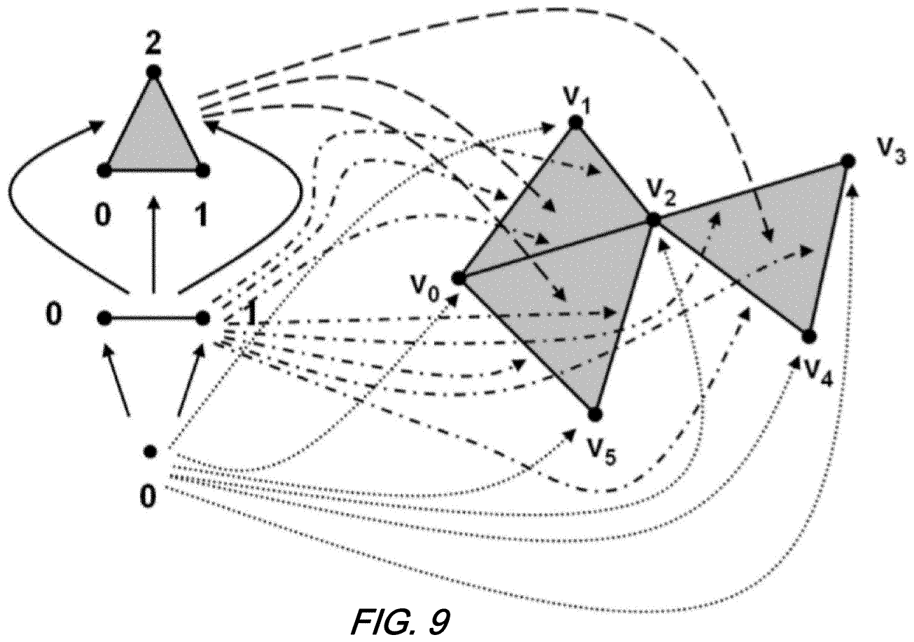

FIG. 9 provides a visualization example without degenerated simplices. We can see in A and the functor—the simplicial sets uniquely extract the topology information—and delete all the other information. It can be used as a representation of the topological data structure.

From Simplicial Set to Fuzzy Simplicial Set

A simplicial set is a neat representation of topology structure; however it is not sufficient in our case. Because the connectivity is binary, we may delete too much information about distance between data points by constructing it. This is the motivation of introducing fuzzy simplicial set. The word ‘Fuzzy’ means that, for any edge in the simplicial complex, we assign it with a proper weight (or say membership strength). And to construct corresponding fuzzy simplicial set, we can just slightly adapt the definition of simplicial sets.

Definition 2 A fuzzy simplicial set is a functor from Δ^{op}×/→Sets.

Here we use the product of two categories, where I be the unit interval (0,1]⊆R is used to reflect the membership strength. We have connectivity information and the weight information; other information is still removed.

With fuzzy set in position, we need to connect fuzzy set with our metric in high-dimensional Euclidian space, so that we can realize this fuzzy simplicial set and evaluate what is a good embedding in aspect of simplicial set. From the prior art, it shows that if we have an extended-pseudo-metric space (X,d) which satisfies subadditivity, reflectivity and half zero-vector property, then construct functor Real, which the realization of fuzzy simplicies Δⁿ_{<a}:

$$Real ( {Δ}_{< a}^{n} ) \overline{=} Δ \{ ( {t}_{0} , … , {t}_{n} ) ∈ {ℝ}^{n + 1} \vert {\sum }_{i = 0}^{n} {t}_{i} = - log - log ( a ) , {t}_{i} \geq 0 \}$$

Thus the metric on Real(Δⁿ_{<a}) is simply inherited from Rⁿ⁺¹. And we define this finite extended-pseudo measure as FinEPMet. Finally, in finite metric spaces, we can define FinSing as the finite fuzzy singular set functor:

FinSing(Y):([n],[0,a))7→hom_{FinEPMet}(FinReal(Δⁿ_{<a}),Y)

And Theorem 1 in UMAP shows both realization and sigular functor are proper functors. Thus FinSing can distill the topological information while still retaining metric information in the fuzzy structure. It means that, we can always use a functor to map every object in metric space, into fuzzy simplicial set such that the natural transformation between FinEPMet and sFuzz are in one-to-one correspondence with the elements of FinReal's image on standard simplices.

As long as we construct a reasonable pseudo metric, it will correspond to one specific fuzzy simplicial set representation. Therefore, in practice, as long as we can find a good functor FinSing (in UMAP, it translates into exponential of the negative distance), based on the pseudo metric, we can estimate the fuzzy representation (A,μ). We use notation aᵢⱼ∈A which represents the connection between xᵢ and xⱼ, and μ is the corresponding membership strength. And we take union over fuzzy sets representation over all data points, we obtain the final fuzzy simplicial set estimator.

Cross Entropy Between Fuzzy Sets

Finally, with FinSing functor, we can optimize low dimension embedding, by minimize the ‘gap’ between high-dimensional and low-dimensional space. The cross entropy C of two fuzzy sets (A,μ) and (A,ν) are applied here.

$$C ( ( A , μ ) , ( A , v ) ) = {\sum }_{a ∈ A}^{ } ( μ ( a ) log ( \frac{μ ( a )}{v ( a )} ) + ( 1 - μ ( a ) log ( \frac{1 - μ ( a )}{1 - v ( a )} ) )$$

Current UMAP Mechanism

Since UMAP is a nonparametric approach based on global topological structure, how to sequentially add new data into training can be challenging. The current UMAP implementation provides umap.transform function to deal with this. The function optimizes the embedding of new testing data, together with current existing data. The difference is that we fix all the embedding for the previous data. It is not ideal for sequentially adding new data or forgetting old data. Consider adding 1 data at each time—this means we need to consider the KNN structure between this point and previous all points. And the current framework does not support online framework, i.e. keep learning new data and forgetting old data at the same time.

An inverse transformation of UMAP has also been proposed. In the inverse transform algorithm, it extract the fuzzy Delaunay simplex, which generates a triangulation which maximum the minimal angels in triangle. It maps lowdimensional data back to original high-dimension, with the reference of original embedding in high-dimensional data. In one aspect, it will mainly mimic the point which is close in embedding.

UMAP with Online Learning

We now describe a framework to adapt UMAP with online learning framework, i.e, with new data coming sequentially.

Online Learning

We now consider two types of online learning approaches. In the first type, we consider new data points coming in batch sequentially, and we would like to graduate update the UMAP to emphasize the topology of new data points and forget old points. In the second type approach, we consider in each iteration we are fed with a new high-dimensional structure of all data points, and we wish to merge their information together to update UMAP embedding, while we wish the make more use from newer iterations and forget older ones gradually.

Sequentially Updated New Data Point

To emphasize the new data and forget old data, the intuitive way is to impose some “weights” to the points based on how new it is. On the one hand, it is worth mentioning that once the data point included in the optimization is determined, the weight should not be on the fuzzy simplicial set itself. Because the fuzzy set is only determined by how “closely related” these points are, this information is not related to whether data points are new or old. On the other hand, we can adapt the entropy between high-dimensional fuzzy set and its low dimension ones. Recall the entropy is:

$$C ( ( A , μ ) , ( A , v ) ) = {\sum }_{a ∈ A}^{ } ( μ ( a ) log ( \frac{μ ( a )}{v ( a )} ) + ( 1 - μ ( a ) log ( \frac{1 - μ ( a )}{1 - v ( a )} ) )$$

The summation is not weighted. It means that each point has equal weight in the graph. While in the online learning case, it is not necessary to be true, since we want to forget old and embrace new data. We would like assign more weights on new ones and less on old ones. For example, we can use:

$$C ( ( A , μ ) , ( A , v ) ) = {\sum }_{{a}_{ij} ∈ A}^{ } w ( {a}_{ij} ) ( ( μ ( a ) log ( \frac{μ ( a )}{v ( a )} ) + ( 1 - μ ( a ) log ( \frac{1 - μ ( a )}{1 - v ( a )} ) ) )$$

with weight function w(aᵢⱼ) defined as:

w(aᵢⱼ)=exp(−a(f(i)+f(j)))1(max{f(i),f(j)}≤f̅)

where f(i) represents the i^{th} data point is introduced in f(i) batch before. a controls the forgetting rate, and f̅ determines the bound that data is older than f̅ batches will be completely ignored.

In algorithm, we seek to minimize:

w(a)μ(a)log(v(a))+wᵢⱼ(1−μ(a))log(1−v(a))ₐ_{ᵢⱼ}_{∈A}

this weight can be adapted in the step of sampling in each embedding optimization iteration. When we sample 1-simplices, instead of using probability μ(aᵢⱼ), we should use p=wᵢⱼμ(aᵢⱼ) in the sampling; In UMAP, they use approximated uniform distribution for negative sampling. In our setting, the formulation provides a vertex sampling distribution:

$$P ( {x}_{i} ) = \frac{{\sum }_{\{ a ∈ A \vert {d}_{0} ( a ) = {x}_{i} \}} w ( a ) ( 1 - μ ( a ) )}{{\sum }_{\{ b ∈ A \vert {d}_{0} ( b ) = {x}_{i} \}} w ( b ) ( 1 - μ ( b ) )}$$

Instead of uniform distribution, it can be reasonably approximated proportion to its weight wᵢⱼ.

Sequentially Updated New Data Mapping

First we assume we construct local fuzzy sets for each iterations as (A⁰,μ⁰), (A¹,μ¹), . . . , (A^{t},μ^{t}), where A⁰ is the latest iteration, and A^{t} is the t^{th} previous iteration. We wish to gradually update UMAP such that it takes information from all these local fuzzy sets and forget old data. The idea is similar to the previous type, we wish our UMAP embedding is similar to all these iterations, with proper assigned weight:

$$C ( ( A , μ ) , ( A , v ) ) = {\sum }_{k = 1}^{ t} w ( k ) {\sum }_{a ∈ {A}^{k}} ( ( {μ}^{k} ( a ) log ( \frac{μ ( a )}{v ( a )} ) + ( 1 - {μ}^{k} ( a ) log ( \frac{1 - μ ( a )}{1 - v ( a )} ) ) )$$

where w(k)=exp(−kα) representing the weights for kth-old iteration. The numerical algorithm can be straight forwardly adapted from standard UMAP. In both positive and negative sampling, we just need to first sampling one iteration A^{k} as a target for this sampling, then we just treat A^{k} as A in standard UMAP algorithm.

This algorithm in general needs to construct one fuzzy set in each iteration, but essentially it will not cost more time in training the low-dimensional embedding. If we wish to project the layers of neural nets, and update UMAP at the same time, then UMAP can be updated in this manner.

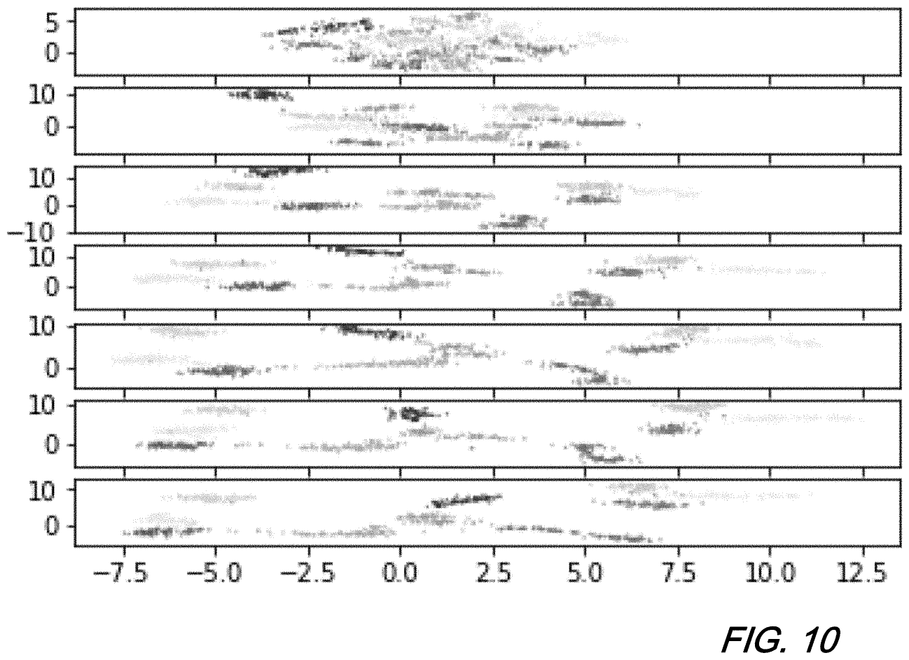

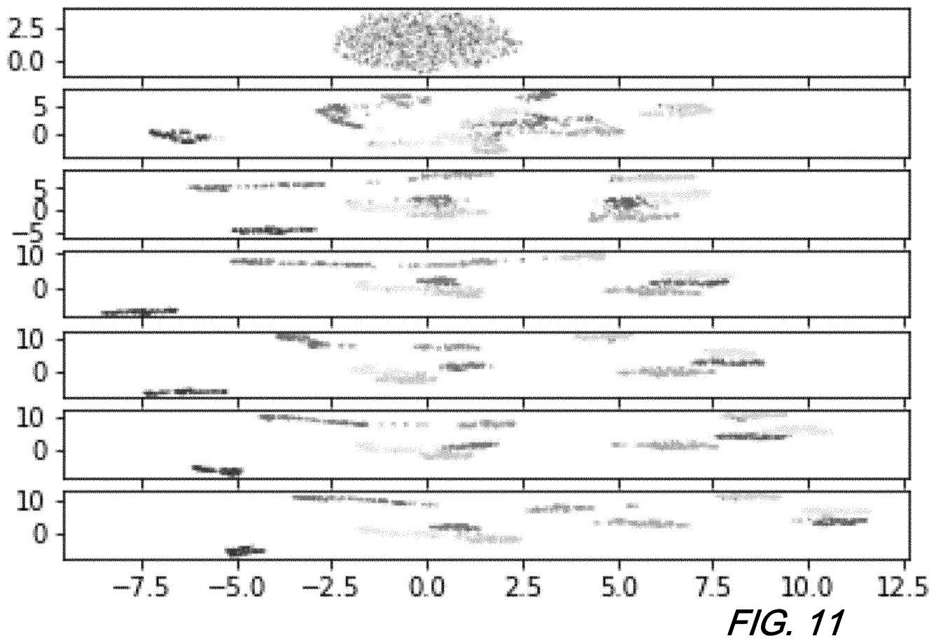

Here we try a toy example on MNIST dataset. We construct a neural network with 2 convolutional layers and 2 fully connected layers, and extract the features after the first fully connected layer to implement UMAP with latest update or updated manner. We record its corresponding UMAP mapping with different number of epochs. We can see the weighted version is more smooth in mapping change, and unweighted version are more likely to jump around. It is more desirable if we want to include UMAP into the training. FIG. 10 is an illustrative plot of a weighted UMAP. FIG. 11 is an illustrative plot of an unweighted UMAP.

Introducing UMAP as a Layer in Network

In this section, we discuss the idea how UMAP (or in general nonparametric dimension reduction technique can be put in the neural network as a layer. The gradients in CNN/FC layers are well defined. The main target is how we can define the gradient in UMAP layer properly, i.e. we need to define ∂y/∂z, where y is the values in low embedding layer and z is the layer in middle layer.

Based on the neighborhood nature of UMAP, the low embedding is determined by the fuzzy set of middle layer, which is constructed fully based on the distance between all data points. And we know that for any two points are not neighbor, we know they won't affect each other's position. This motivates us to calculate the gradient

$$\frac{\partial {y}_{i}}{\partial {z}_{j}} ,$$

which is the effect of i^{th} observation. We can approximate it as:

$$\frac{\partial {y}_{i}}{\partial {z}_{j}} = {\sum }_{k ∈ NN ( i )} \frac{\partial {y}_{i}}{\partial {v}_{ik}} \frac{\partial {v}_{ik}}{\partial {μ}_{ik}} \frac{\partial {μ}_{ik}}{\partial {z}_{j}}$$

where NN(i) represents the k nearest neighbor of point i. where we originally approximate

$$\frac{\partial {v}_{ij}}{\partial {μ}_{ij}} = 1 ,$$

considering the case changing only one neighbor, vᵢⱼ will exactly mimic the value of μᵢⱼ, therefore their changes should be proportion to each other. And here we also consider a finer approximation of this term. Considering the equation:

C=^{x}μ log(μ/v)+(1−μ)log((1−μ)/(1−v)

If the equation holds when we take derivatives, we have:

$$\frac{\partial C}{\partial v} \frac{\partial v}{\partial μ} \frac{\partial μ}{\partial C} = 1$$

Therefore, we can approximate:

$$\frac{\partial {v}_{ij}}{\partial {μ}_{ij}} = \frac{\partial C}{\partial {μ}_{ij}} / \frac{\partial C}{\partial {v}_{ij}} = \frac{v ( 1 - v ) log \frac{μ - μ v}{v - μ v}}{μ - v}$$

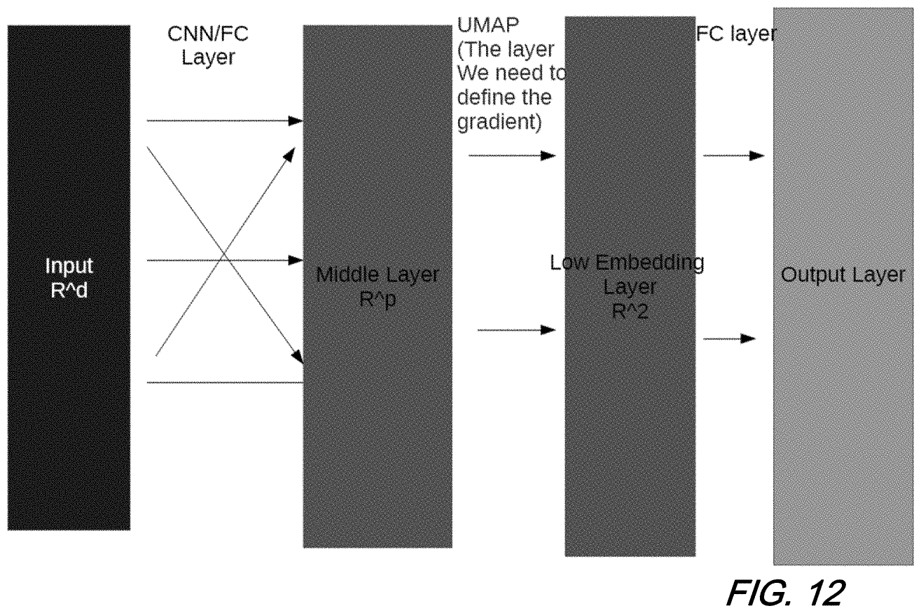

We observe that this approximated term is always positive when μ,v∈(0,1). Therefore it can be regraded as a weight adjusting the previous ‘equal to 1’ approximation. FIG. 12 is a schematic diagram showing a network structure with UMAP.

And we calculate the explicit gradient of other parts:

$$\frac{\partial {y}_{i}}{\partial {v}_{ik}} = {( \frac{\partial {v}_{ik}}{\partial {y}_{i}} )}^{- 1} = - exp ( {d}_{ik} - min\_dist ) direction ( {y}_{i} - {y}_{k} )$$

$$\frac{\partial {μ}_{ik}}{\partial {z}_{j}} = \frac{\partial {μ}_{ik}}{\partial {d}_{ik}} \frac{\partial {d}_{ik}}{\partial {z}_{j}} + \frac{\partial {μ}_{ik}}{\partial {ρ}_{i}} \frac{\partial {ρ}_{i}}{\partial {z}_{j}} + \frac{\partial {μ}_{ik}}{\partial {σ}_{ik}} \frac{\partial {σ}_{i}}{\partial {z}_{j}}$$

Where we can separately calculate three terms:

$$\frac{\partial {d}_{ik}}{\partial {z}_{j}} = {1}_{\{ k = j \}} \frac{exp ( - ( d ( {z}_{i} , {z}_{j} ) - {ρ}_{i} ) ) direction ( {x}_{i} - {x}_{j} )}{{σ}_{i}}$$

$$\frac{\partial {ρ}_{i}}{\partial {z}_{j}} = - {1}_{\{ j is n , n \}} \frac{exp ( - ( d ( {z}_{i} , {z}_{j} ) - {ρ}_{i} ) ) direction ( {x}_{i} - {x}_{j} )}{{σ}_{i}}$$

$$\frac{\partial {σ}_{i}}{\partial {z}_{j}} = - {( \frac{\partial f}{\partial {σ}_{i}} )}^{- 1} ( \frac{\partial {d}_{ij}}{\partial {z}_{j}} \frac{\partial f}{\partial {d}_{ij}} + \frac{\partial {ρ}_{i}}{\partial {z}_{j}} \frac{\partial f}{\partial {ρ}_{i}} ) where$$

$$f = {\sum }_{k ∈ NN ( i )} exp ( - ( {d}_{ik} - {ρ}_{i} ) / {σ}_{i} ) , is a function of {d}_{ik ,} {ρ}_{i} and {σ}_{i}$$

$$To this end , we complete the derivation of gradient term \frac{\partial {y}_{i}}{\partial {z}_{j}} . Then we can$$

To this end, we complete the derivation of gradient term

$$\frac{\partial {y}_{i}}{\partial {z}_{j}} .$$

Then we can use chain rule to derive:

$$\frac{\partial loss}{\partial {z}_{j}} = {\sum }_{i = 1}^{n} \frac{\partial loss}{\partial {y}_{i}} \frac{\partial {y}_{i}}{\partial {z}_{j}}$$

Then we have all the pieces for back propagation. The intuition of this nonparameteric layer is that we wish to find a high-dimensional embedding such that its corresponding UMAP structure has good performance on loss function (Classification/Regression/Autoencoder etc.). This also corresponds to the UMAP updating procedure. We just change the attractive forces proportion to their gradient change.

Gradients in UMAP Layer

We implement the back propagation with designed gradient in last section. We found the result is still not optimal, and the high embedding x jumped around and cannot be stable at a location with reasonable embedding. The main reason comes from the approximation of

$$\frac{\partial v}{\partial μ} .$$

We assume their changes should be proportion to each other. However, this is a one point case. There are two inner reasons why it may not be a good approximation, and this term is not tractable in general.

First, in high dimension space calculating μ, we estimate ρ and σ to meet the uniform manifold assumption. It has sum of weight constrain(log₂ k). However, we target at a euclidian space in v, where we don't have these constraints.

Second, in the UMAP algorithm, it remove all the location information to construct local fuzzy simplical set. However, we wish to update the coordinate with respect to dy/dx. It means that only from v and μ, we cannot really infer all the necessary location information to derive the partial gradient. It cannot only be a function of μ and v, but heavily depends on the location y and x. However, it will break the chain rule. Therefore it is a central problem that whether we can have a good approximation of dy/dx.

To further investigate the performance of our ‘approximation’, we implemented the exact stochastic gradient descent UMAP without random positive/negative sampling. The procedure is as follows.

Write a function which achieve SGD on UMAP cross entropy loss to solve low embedding.

Update one coordinate of Xⱼ by δ, and resolve SGD on UMAP while we only update yᵢ^{new} at this time, with the current low embedding as initialization, making sure the update is smooth.

By definition of numerical gradient, we have

$$\frac{{dy}_{i}}{{dX}_{j}} = \frac{{y}_{i}^{new} - {y}_{i}}{δ}$$

In this way, the numerical gradient is quite different from the approximated gradient, and in many cases even the sign is wrong.

Further consider back propagation using exact numerical gradient, it should be a fair test on whether the back propagation on

$$\frac{{dy}_{i}}{{dz}_{j}}$$

is good enough to recover the high-dimensional structure. We still consider the 12 points example. We found that when we start from point close to real points, the gradients are very reasonable, and they tends to scatter or concentrate towards the diagonal direction according to its current membership strength. However, after several updates, it becomes a little bit off and may go wild; And if we start with random initialization, the points still cannot recover the correct direction.

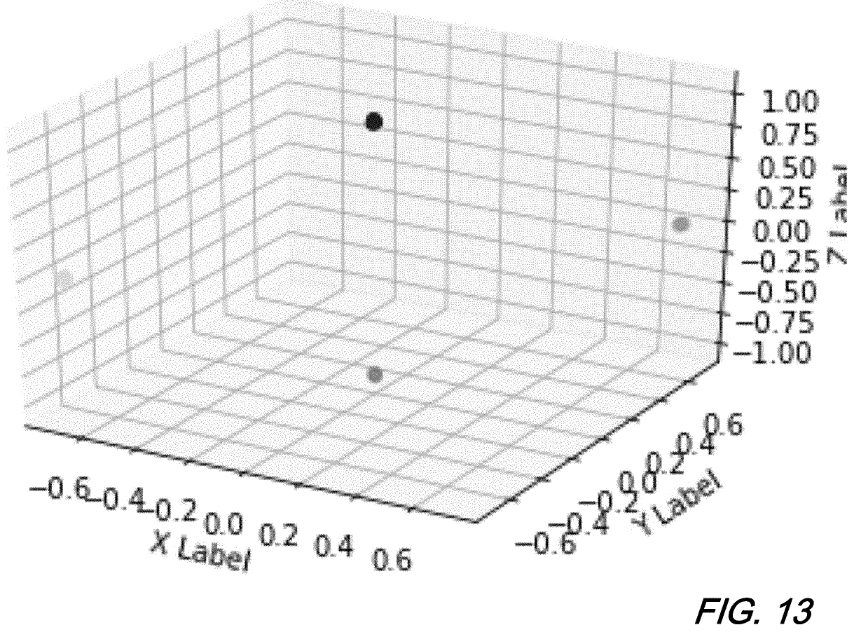

In 12 points example, we make several observations: (1) In a good scaled point. ITs corresponding embedding is pretty good up to scale transformation. FIG. 13 is a plot illustrating a 12 points example.

Also, the gradients are fairly reasonable, we consider the case both we consider the gradient w.r.t to one other point, or w.r.t to all the points. In the one point case, the gradients will be the direction to push points away.

Import UMAP as a Layer

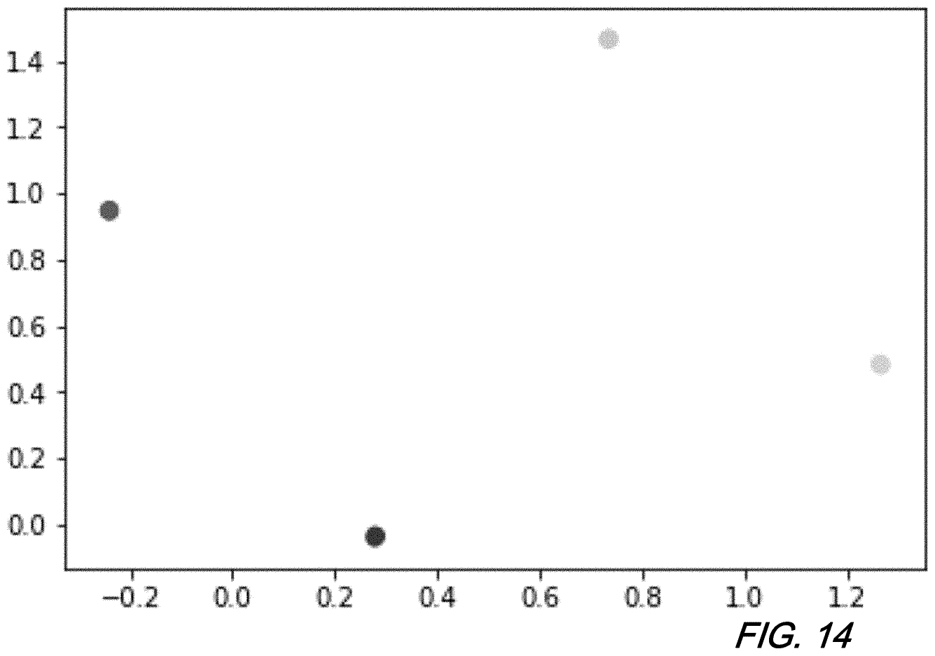

In this section, we consider implementing an ‘UMAP’ layer which can be used in standard neural network framework. This can be achieved by defining a pytorch autograd class with self-defined forward and backward function. FIG. 14 is a plot illustrating 12 points embedding.

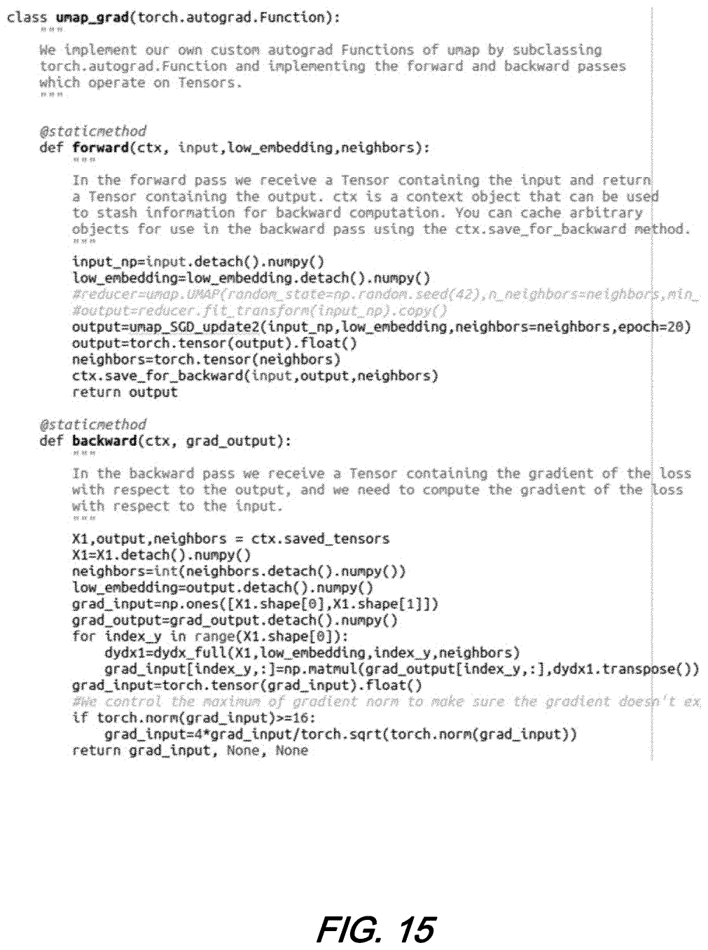

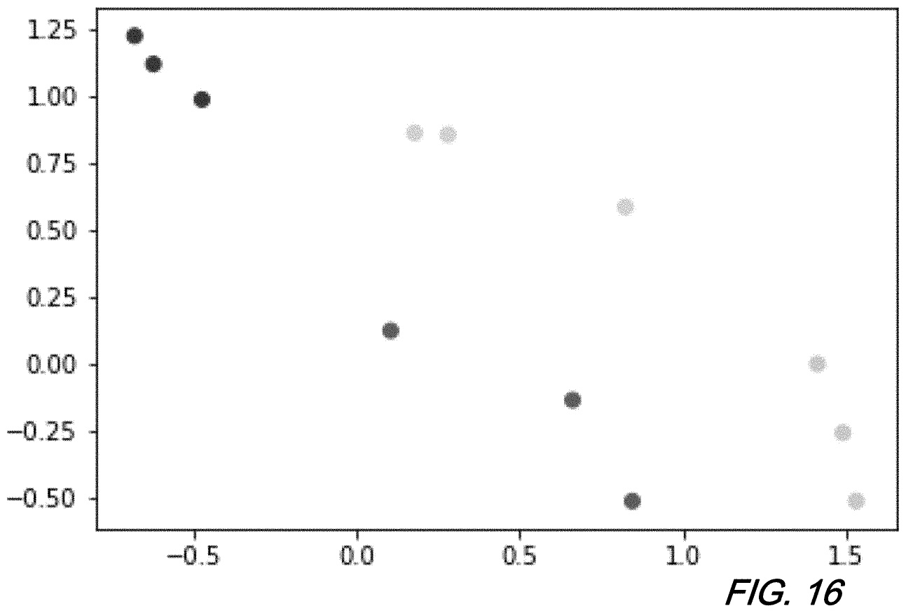

FIG. 16 is a plot showing an illustrative realization of 2-D embedding after training. There are a few adaptions we made in this example. So far we are using our self-wrote exact SGD to solve the UMAP. In this way, we avoid bias introduced by randomness in small datasets, and also makes the result more trackable. In each forward step, we update low-dimensional embedding of UMAP from last iterations with not too many update epochs. In this way we control the UMAP not changing too much such that the parameters after UMAP layer can also by updated steadily. We found relatively high learning rate works better in this case, since we must need large enough attractive force to update the relative neighborhood of points. Otherwise they will stick around the initialized embedding. FIG. 15 is an illustrative defined UMAP layer.

First we still try our 12-points example. This time we treat them as four classes, and impose a negative likelihood loss. In this experiment, we have one fully connected layer ahead of UMAP layer, and another fully connected layer after UMAP layer. In most of cases, the loss function converges to something very close to zero, and the four classes are separated well. Then we move to study the MNIST data set. To begin with, we still use our exact SGD algorithm to solve UMAP, and don't use any approximation or random sampling technique.

Since the current exact SGD algorithm requires us to use all the data in each iterations, so we cannot use mini batch for now. It will be important work in next step. We current use SGD update in the global SGD also.

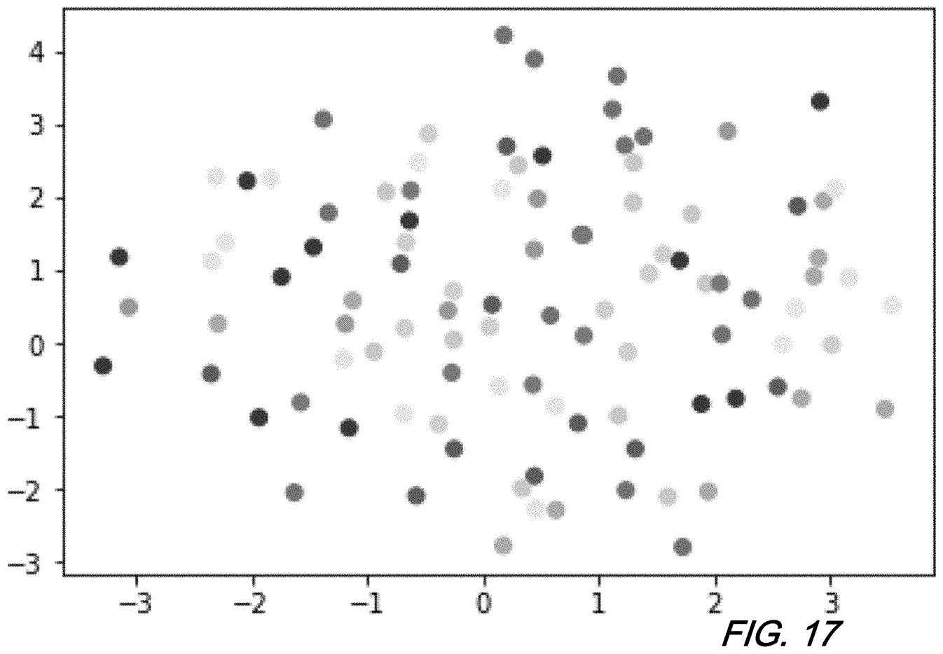

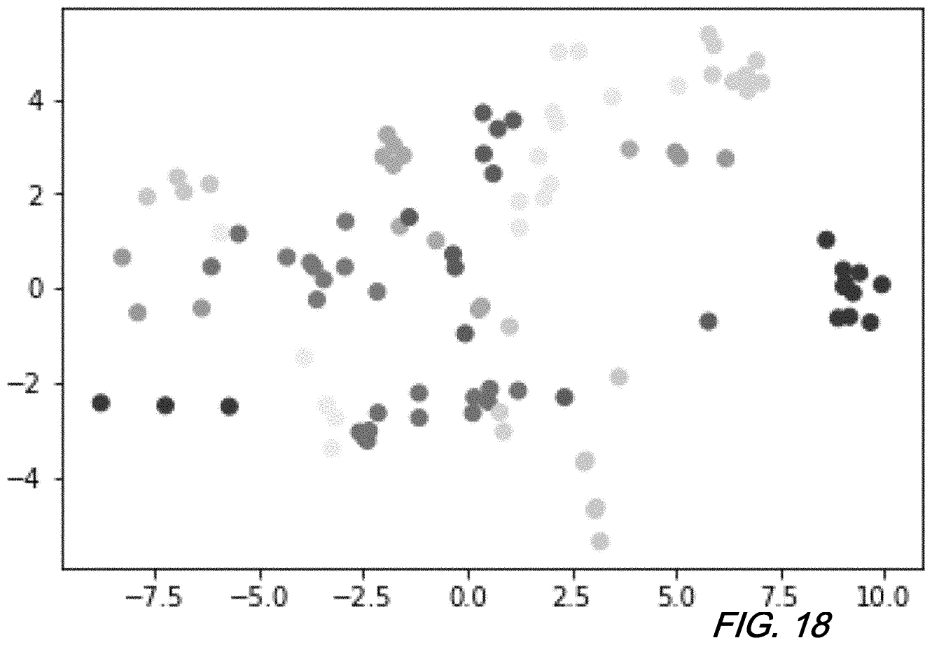

We use a standard CNN framework on MNIST dataset with replacing a full-connected layer with UMAP layer: A convolution layer with 20 out channels and kernel size 5*5 and pool 2*2. A convolution layer with 50 out channels and kernel size 5*5 and pool 2*2. Fully connected layers from 800 to 500 and 500 to 10. UMAP layer projecting 10-dimension to 2-dimension. Fully connected layers from 2 to 2 dimension and 2 to 10 dimension. Considering the large sample size(60000), here we use first 100 samples for the current small experiment. We found the loss function will decrease in general, but when the update affect the essential neighborhood information, the loss value can jump around. After around 2500 iterations, the low-dimensional embedding is plotted as follows in FIG. 16. FIG. 17 is a plot illustrating embedding before training and FIG. 18 is a plot illustrating embedding after training.

And the loss stables around 0.98. And it can jump above sometimes when neighbor's info is changed, and the weights have not adjusted to the new neighbors. From the plot, we can see that we do have many classes concentrating together, however the neighbors update can be really hard, and we cannot get a stable solution.

Issue in UMAP Layer Idea

In practice, we observe that there are two major issues in current network architecture: The UMAP updates is unstable, and usually glue points together. This leads to the increasing in loss function with UMAP updates. The scale term a tends to explode to be really high, and it means the structure between points are not ideal.

To deal with these issues, we consider a few approaches: Update UMAP embedding in every 50 iterations to stabilize the weights in network. Force a to be small to avoid high intrinsic dimensionality. Update UMAP embedding in batch to improve stability.

However, these approaches still lead to a converging loss function in iteration. The main issue I think is still that the directional gradient approximation is not good enough.

Neighborhood Preserving Layer

As discussed, the major difficulty is the back prop cannot really help change the low embedding in the way we expect. So the natural idea is what if we update low embedding itself in back prop? Then we came up with the following experiment:

In this framework, we pretrained convolution layer, and compute its embedding with membership strength matrix μ. Then we update UMAP embedding which composes both UMAP cross entropy loss referring to μ, and the classification negative loglikelihood loss. After training the model, we can predict new model using the transform function in UMAP module, with the reference of all current embedding. The classification error rate is quite low in this case, and the low embedding of training and testing set are as follows: We can see different classes are separated quite well, and the linear pattern is due to the one fully-connected layer structure in our neural nets.

The key message is that μ is sufficient to help us achieve a good low embedding, if the high embedding itself is reasonable. It motivates us to think about back prop in a different way. Recall our gradient approximation:

$$\frac{\partial {y}_{i}}{\partial {z}_{j}} = {\sum }_{k ϵ NN ( i )} \frac{\partial {y}_{i}}{\partial {v}_{ik}} \frac{\partial {v}_{ik}}{\partial {μ}_{ik}} \frac{\partial {μ}_{ik}}{\partial {z}_{j}}$$

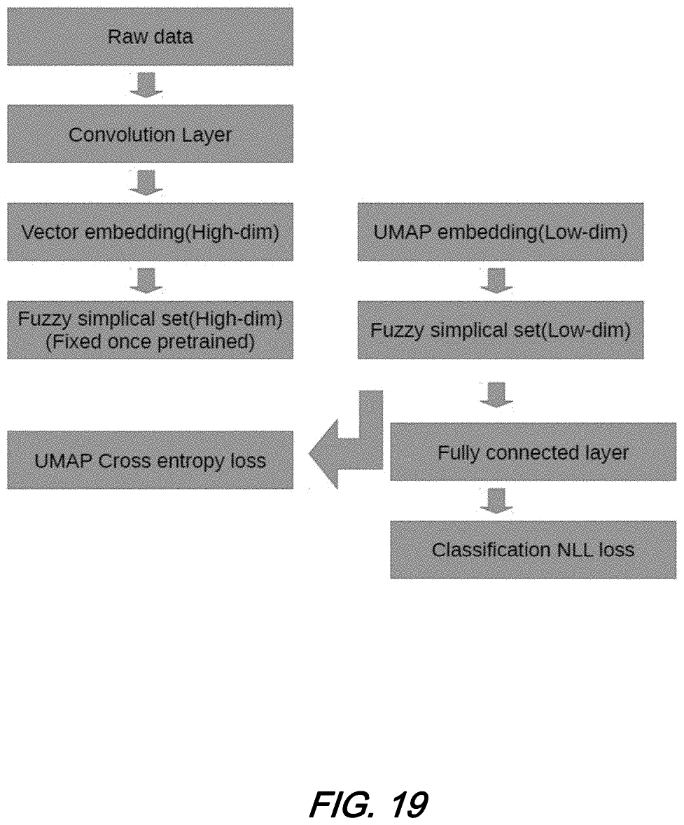

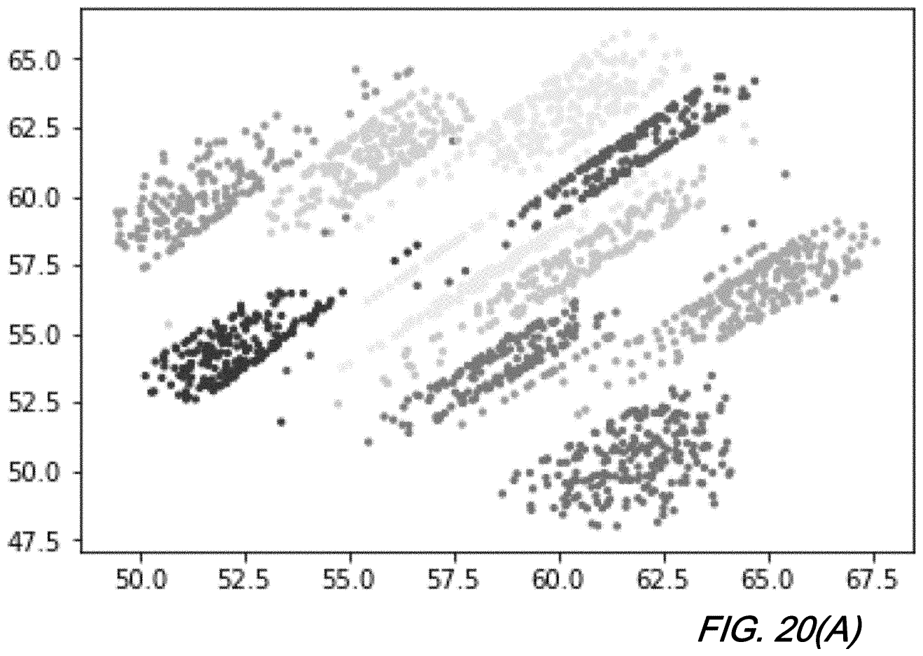

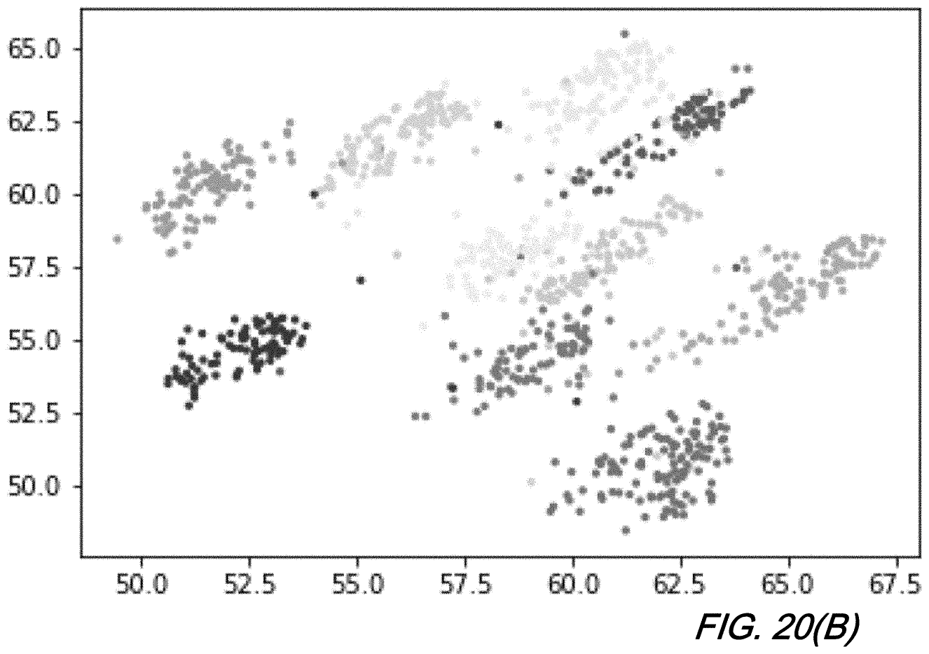

We have exact solution of first and last term, just do not have a good approximation of middle term. Based on the previous experiment, actually we can avoid calculating this full term, by introducing μ into the network: We can see comparing to our previous experiment, the key difference is that μ is in the network now, and it will be updated through back propagation. By introducing μ itself into the network, we can use back prop to compute the gradient of loss with respect to μ. And as we mentioned, we have exact gradient formula of μ term, therefore it can be straightforwardly back prop into convolution layer, by defining a new layer of ‘computing μ’. In this way, we broke the one-to-one mapping from high embedding to low embedding but update them together jointly by introducing UMAP cross entropy loss in the neural nets. Comparing to our previous structure, we assume a one-to-one mapping from μ to v, which is very hard to approximate, and if the initialization is bad, it is very hard to update to current position. The current structure allows the message from low embedding also influences the high embedding, thus correcting the direction of updates in high embedding. FIG. 19 is a schematic block diagram showing updating embedding with pretrained network.

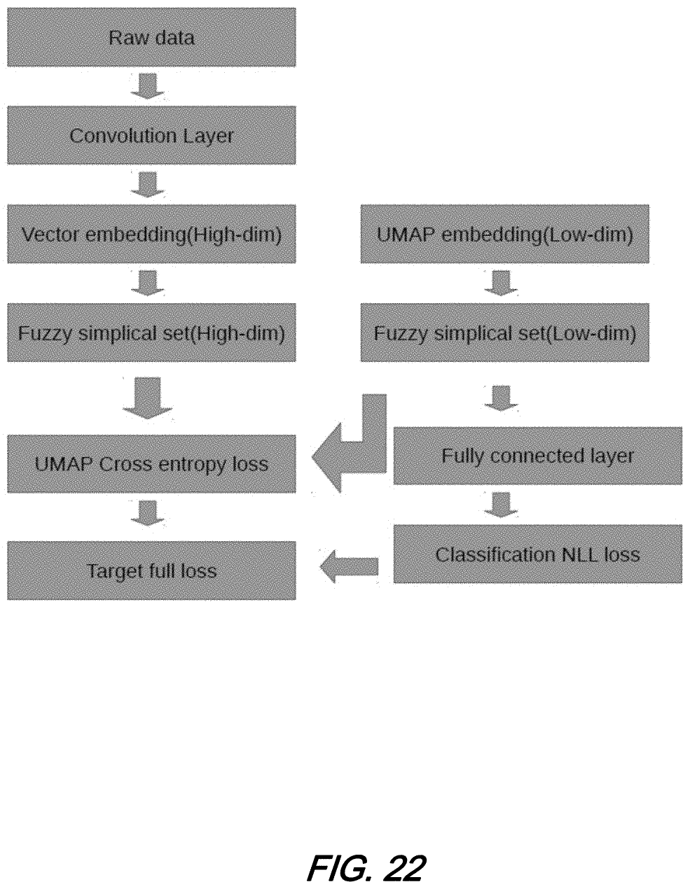

In experiment on MNIST dataset, the loss function converges pretty well, the a is very stable, and different classes separates well in low embedding. A 100 samples training embedding example is provided in FIG. 14(A) and FIG. 14(B) which show embedding with fixed pretrained convolution layers for training (2000 points) and testing (1000) respectively. We can see their pattern is pretty similar to pretrained ones, and it makes sense for classification with 1 relu-fc layer. The classification loss goes down to smaller than 0.1 (comparable with standard CNN) in this case. FIG. 22 is a plot showing training embedding according to our new architecture.

One concern is the backward layer of computing μ is very slow, since it requires tons of matrix multiplication. It is worth exploring how to speed up this back prop step.

Autograd and Batch Learning

Autograd

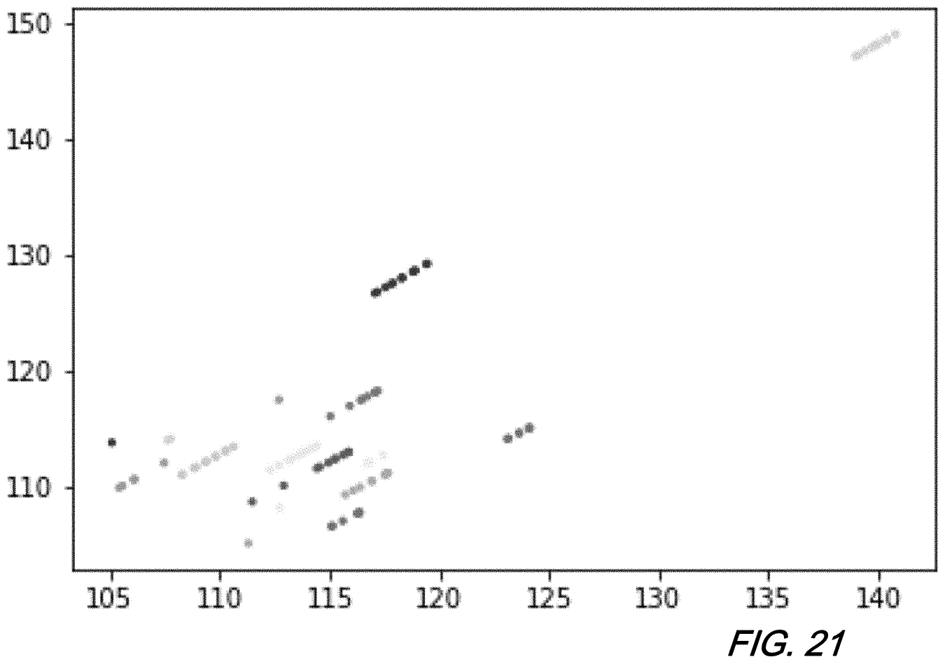

To speed up the back propagation, we consider writing the self-defined layer in tensor(from the high-dimensional embedding Z to ϕ. To make the Autograd applicable, here we link the gradient through d(zᵢ,zⱼ) only, and ignore the effect of ρ and σ. We calculate these parameters using the same approach with UMAP paper, and don't include them in the graph, since their effect is small and can be ignored. FIG. 21 is a block diagram illustrating out new network architecture.

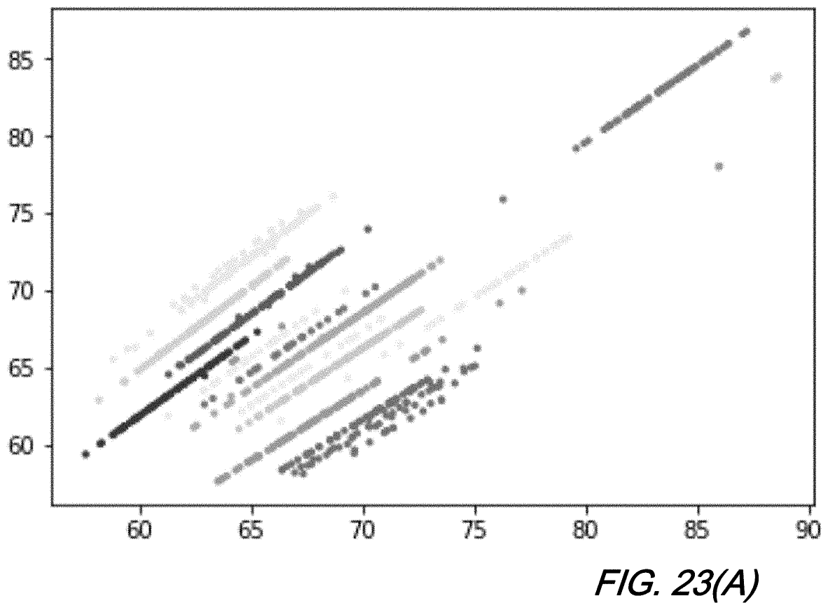

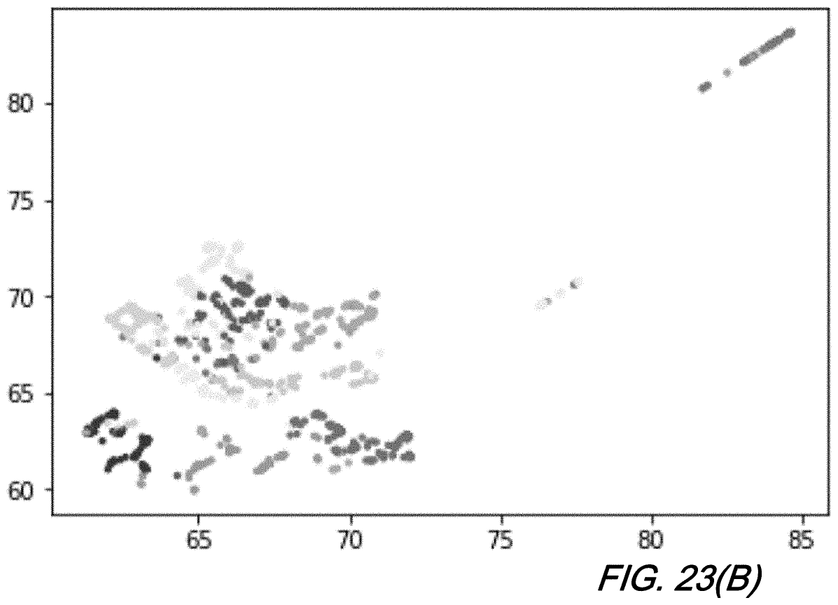

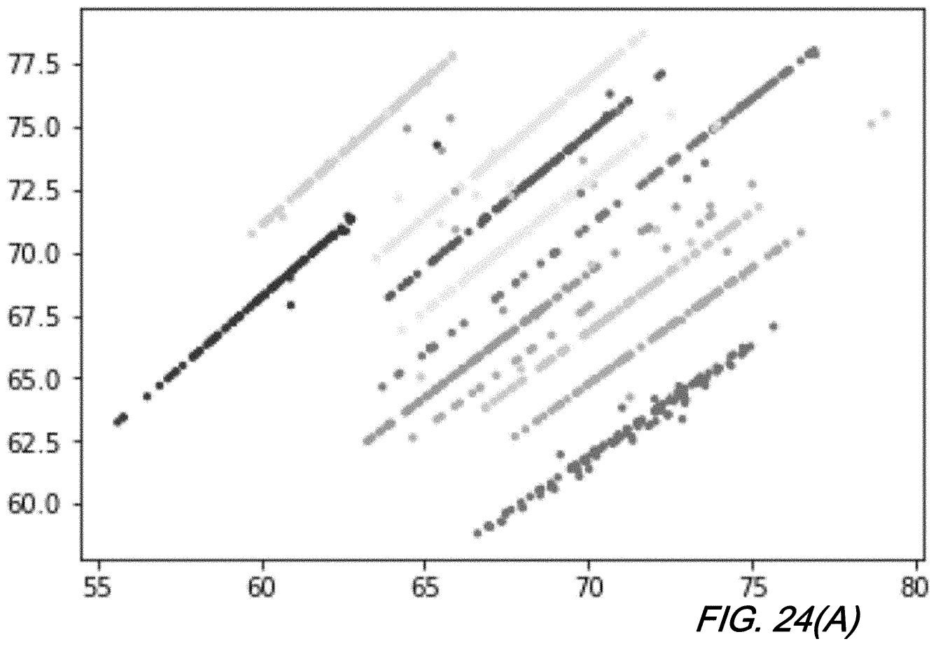

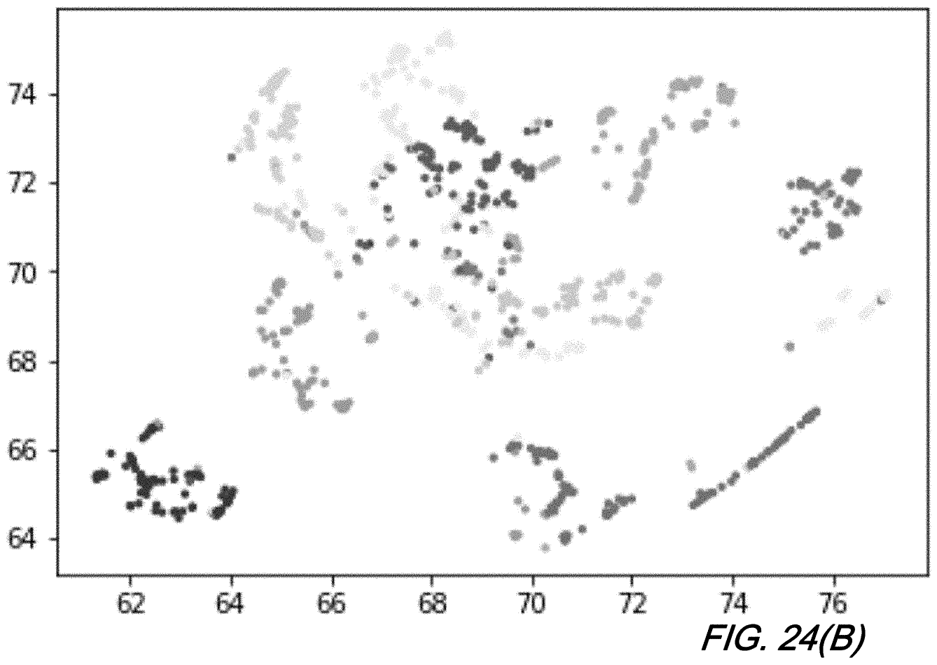

By making this adaption, the algorithm is fast enough to deal with batch size 1000˜2000. And we find a few things can be discussed to improve the performance and robustness: Put ′₂ regularization on network to control the intrinsic dimensionality. Comparison is provided in plots in FIGS. 23(A), 23(B), and 24(A), and 24(B). Alternative update ratios between convolution layers and fully-connected layers. High ratio will make the low embedding of each class more concentrated on a line, will lower ratio will increase the classification loss a bit, and make the low embedding of each class more spread out. How to deal with the membership strength close to 0 and 1. Now we use μ=0.98*μ+0.01, mapping it linearly to (0.01,0.99) to avoid extreme values.

From the plots, we can see that when we impose regularization, different classes are more separated and also easy to identify in testing set.

Batch Learning

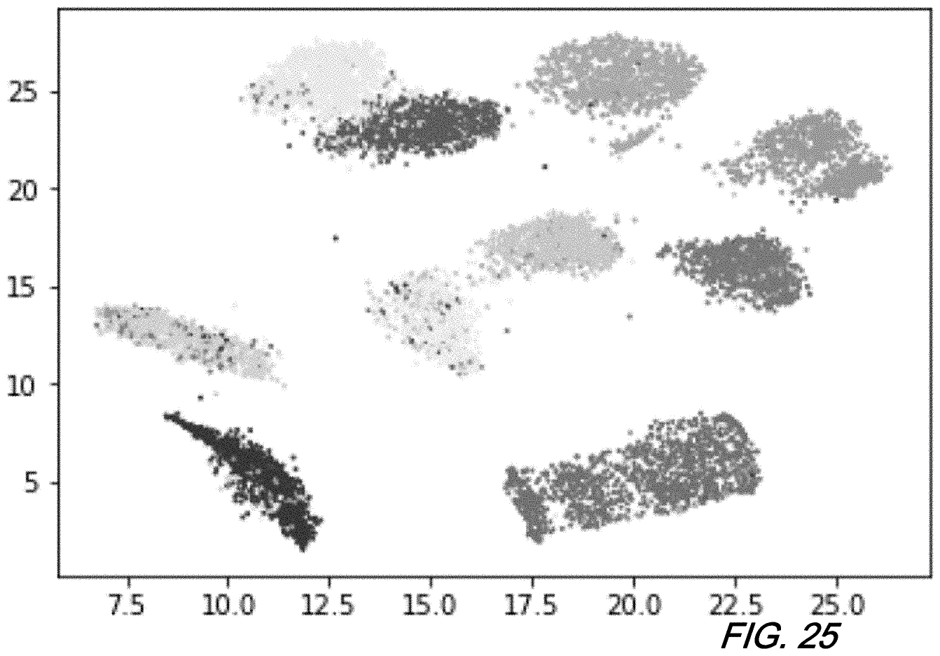

It is obviously that it is not realistic to train the model on the whole data set. Therefore, we further consider batch learning techniques here. Since UMAP assumes data set is uniformly distributed on a low-dimensional manifold. Therefore, if we random sub-sample the data, the assumption still holds. And we can still use the same approach to train the network. This fact justifies that we can use batch learning technique here in training network. However, there is one important adaption we need to make. To stabilize the low embedding, for each batch, we need to fix the low embedding of other points same, and only update the low embedding of specific points in batch. In this way, we guarantee the low embedding is stable from batch to batch. Here we provided the plots of low-dimensional embedding from whole training dataset (60000 points) and testing dataset (10000 points) after 5 few epochs. FIG. 25 shows the batch learning results (50 epochs). From the results, we can see that different classes are well separated in both training and testing data sets. And we also get rid of the undesired concentration on the line for each class. Also, the testing accuracy is ˜82%. We calculate the likelihood estimator of intrinsic dimension over all training samples. We found it ranges from 1.745 to 29.211 with mean 5.768. It is reasonably low in general.

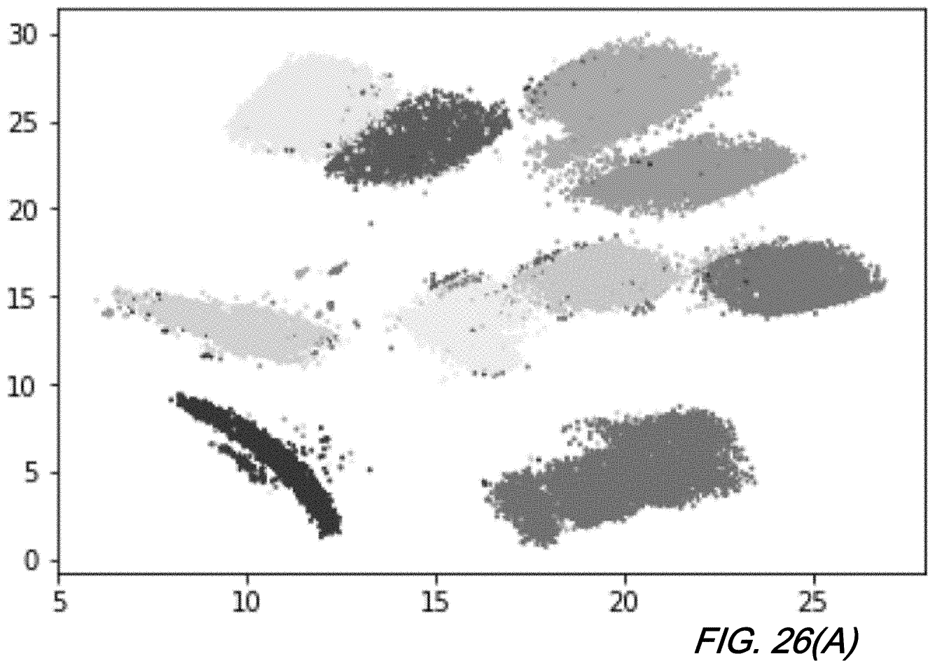

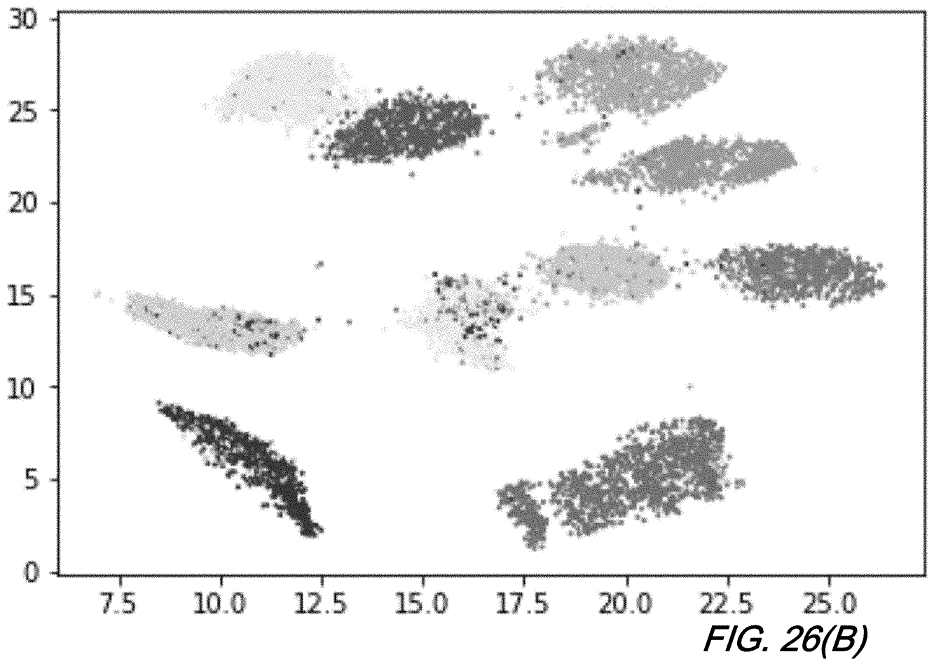

And the potential improvement/problems can be: Is 2 fully-connected layer with one Relu activation is capable enough to sufficiently separate 10 classes with complicated shapes? Since we observe that after several batches, the training classification losses for batches are concentrated around 0.4-0.5, it should be smaller. When I add a layer, the training classification error tends to be smaller. And the testing accuracy improves to ˜87%. Their embedding plots are also presented. What is the proper regularization to control the intrinsic dimensionality? Now we use ′₂ regularizations on the convolution networks. What is the optimal batch learning structure? Now for each batch, we only calculate μ and v inside the batch, to reduce the computation complexity. We don't use the global graph information here. It may not be the most ideal way. FIG. 26(A) and FIG. 26(B) are plots showing training set embedding and testing set embedding for batch learning with deeper layer (50 epochs).

Theoretical Analysis on Network with Neighborhood Preserving Layer

First we consider exact the same neighborhood weighted average approach as we use in predicting our new points:

$$f ( {x}_{0} ) = \frac{{\sum }_{i = 1}^{n} {w}_{i} {y}_{i}}{{\sum }_{i = 1}^{n} {w}_{i}} for neighbors \{ {x}_{1} , … , {x}_{n} \}$$

where yᵢ is the corresponding low dimensional embedding of xᵢ accordingly. Here we introduce another assumption to bound the neighborhood update frequency. It represents the ratio of points changed as an Bᵣ-ball move by a small

ASSUMPTION 1. x follows a distribution P. We assume P is uniformly bounded with density almost everywhere.

LEMMA 1. For every point x₀, we assume there exist C₃>0 such that:

$${lim}_{n \to ∞} {lim}_{{‖ ϵ ‖}_{2} \to 0} \frac{\begin{matrix}{Card}_{x} ( x ∈ {𝔹}_{r} ( {x}_{0} ) , x ∉ {𝔹}_{r} ( {x}_{0} + ϵ ) ) + \\ {Card}_{x} ( x ∈ {𝔹}_{r} ( {x}_{0} + ϵ ) , x ∉ {𝔹}_{r} ( {x}_{0} ) )\end{matrix}}{n ϵ} < {C}_{3}$$

Proof. For any, we can calculate the volume of the intersection of two high dimensional balls and their symmetric difference. Referring to (Li 2011), we have:

$$\frac{vol ( {𝔹}_{r} ( {x}_{0} ) Δ {𝔹}_{r} ( {x}_{0} + ϵ ) )}{vol ( {𝔹}_{r} ( {x}_{0} ) )} = {I}_{1 - {( ϵ / 2 r )}^{2}} ( \frac{d + 1}{2} , \frac{1}{2} )$$

where Δ is symmetric difference operator such that AΔB=(A∩B^{C})∪(A^{c}∩B); | is the regularized incomplete beta function:

$${𝕀}_{r} ( a , b ) = \frac{{\int }_{0}^{r} {{x}^{a} ( 1 - x )}^{b} dx}{{\int }_{0}^{1} {{x}^{a} ( 1 - x )}^{b} dx} = 1 - \frac{{\int }_{r}^{1} {{x}^{a} ( 1 - x )}^{b} dx}{{\int }_{0}^{1} {{x}^{a} ( 1 - x )}^{b} dx}$$

We know as ϵ→0, 1−(ϵ/2r)²→1, (1−x)/ϵ→0 for x>1−(ϵ/2r)² as ϵ→0, thus we can find arbitrarily small constant C′₃ such that

$$\frac{vol ( {𝔹}_{r} ( {x}_{0} ) Δ {𝔹}_{r} ( {x}_{0} + ϵ ) )}{ϵ * vol ( {𝔹}_{r} ( {x}_{0} ) )} < {C}_{3}^{′}$$

for sufficient small epsilon. Further, we say a distribution is an α-even distribution if for any two regions with same volume A,B in feasible region S, such that for a sample point x∈P:

$${max}_{vol ( A ) vol ( B )} \frac{p ( x ∈ A )}{p ( x ∈ B )} \leq α$$

All the uniformly bounded distribution with density almost everywhere can be represented as an α-even distribution since their density is both upper and lower bounded. And for α-even distribution, by definition, we have C₃<αC′₃. Therefore we can always find corresponding α, and then a desirable C₃ for all distribution under assumption 1.

Another assumption is that all the points in Bᵣ(x₀) and [symbol] ᵣ(x₀+ϵ) are uniformly bounded in aspect of ′l₂ norm.

ASSUMPTION 2. For point x₀, we assume for any points xᵢ∈ [symbol] ᵣ(x₀), its' embedding yᵢ satisfies that ∥yᵢ∥₂≤C₄.

Since our goal is to obtain a behaved low-dimensional embedding. Therefore such regularization bound is reasonable in our setting. We also introduce necessary notations. For a scalar function h(z), we use cov_{z∈S}(z,h(z)) to represent the element-wise population covariance between each element in random vector z and a random scalar h(z) inside set S for z follows the distribution constrained in set S. It has same dimension with z. Further, for data point x₀, we assume its neighbors in Bᵣ(x₀) are x₁, . . . , xₙ and their embeddings are y₁, . . . , yₙ. Their distances to x₀ are denoted as d(x₀,xᵢ) for i=1, . . . , n. And we assume their weights wᵢ=exp(−d(x₀,xᵢ)).

THEOREM 1. Suppose data follows distribution P in space R^{p}, and we uniformly sample N points from P. For point x₀, we assume the weight of i^{th} nearest neighbor is wᵢ=h(d(x₀,xᵢ)) where h(·) is a non-increasing function. We denote C₁=E_{z∈Br(x}_{₀}₎(d(x₀,z)) and C₂=E_{z∈Br(x}_{₀}₎|h (d(x₀,z))|. C₃ is the upper bound for portion of changing point, and kyᵢk₂≤C₄. Then for any δ>0 and any nonmed direction u such that ku\hat{ }k₂=1, we can find sufficient large N such that:

$${lim}_{c \to 0} {‖ \frac{f ( {x}_{0} + c \hat{u} ) - f ( {x}_{0} )}{c} ‖}_{2} \leq 2 {C}_{4} ( \frac{{C}_{1}}{{C}_{2}} + {C}_{3} ) + δ$$

REMARK 1. From the theorem, we see that the lipschitz bound of neighborhood weighted embedding is determined by (C₁, C₂, C₃, C₄). And by the definition, we know C₁≤1 by our choice of radius r; C₂ is lower bounded as long as we choose a function decay sufficiently fast. For example, if we choose h(x)=exp(−x), we have C₂≤1; C₃ and C₄ are also small constant independent of p. Therefore, the lipschitz bound of our neighborhood embedding layer is smaller and will not diverge with p, and free from the scale of x.

Proof. The proof is separated into two parts. Firstly we consider the derivative w.r.t to x if there is no updates in neighbors. Secondly we consider the case of neighbor change.

First, if no neighbor change, we can just consider derivatives w.r.t to every possible high dimensional embedding of x₀. Denoting

$${g}_{i} ( {x}_{0} ) = \frac{{w}_{i}}{{\sum }_{i = 1}^{n} {w}_{i}} ,$$

we can calculate the derivatives on specific direction such that ∥ϵ∥₂=1:

$$\begin{matrix}{lim}_{c \to 0} \frac{f ( {x}_{0} + c ϵ ) - f ( {x}_{0} )}{c} = {\sum }_{i = 1}^{n} {y}_{i} {lim}_{υ \to 0} \frac{{g}_{i} ( x + c ϵ ) - {g}_{i} ( x )}{c} \\ = {\sum }_{i = 1}^{n} {y}_{i} \frac{{w}_{i}^{′} ( x ) {\sum }_{i = 1}^{n} {w}_{i} - {w}_{i} {\sum }_{i = 1}^{n} {w}_{i}^{′} ( x )}{{( {\sum }_{i = 1}^{n} {w}_{i} )}^{2}} \\ = \frac{{\sum }_{i = 1}^{n} {y}_{i} {w}_{i}^{′} ( x )}{{\sum }_{i = 1}^{n} {w}_{i}} - \frac{{\sum }_{i = 1}^{n} {w}_{i}^{′} ( x ) {\sum }_{i = 1}^{n} {y}_{i} {w}_{i}}{{( {\sum }_{i = 1}^{n} {w}_{i} )}^{2}} \\ = \frac{{\sum }_{i = 1}^{n} {y}_{i} {w}_{i}^{′} ( x ) / n}{{\sum }_{i = 1}^{n} {w}_{i} / n} - \frac{{\sum }_{i = 1}^{n} {w}_{i}^{′} ( x ) / n {\sum }_{i = 1}^{n} {y}_{i} {w}_{i} / n}{{( {\sum }_{i = 1}^{n} {w}_{i} / n )}^{2}} ,\end{matrix}$$

where

$${w}_{i}^{′} ( x ) = {lim}_{c \to 0} \frac{{w}_{i}^{′} ( x + c ϵ ) - {w}_{i} ( x )}{c} ,$$

is the gradient of wᵢ(x) on specific direction. Therefore we can bound its [symbol] ₂ norm as:

$${‖ {lim}_{c \to 0} \frac{f ( {x}_{0} + c ϵ ) - f ( {x}_{0} )}{c} ‖}_{2} \leq {C}_{4} ( \vert \frac{{\sum }_{i = 1}^{n} \vert {w}_{i}^{′} ( x ) \vert / n}{{\sum }_{i = 1}^{n} {w}_{i} / n} \vert + \vert \frac{{\sum }_{i = 1}^{n} \vert {w}_{i}^{′} ( x ) \vert / n {\sum }_{i = 1}^{n} {w}_{i} / n}{{( {\sum }_{i = 1}^{n} {w}_{i} / n )}^{2}} \vert ) \leq {C}_{4} ( \frac{{\sum }_{i = 1}^{n} \vert {h}^{′} ( d ( {x}_{0} , {x}_{i} ) ) \vert / n}{{\sum }_{i = 1}^{n} {w}_{i} / n} + \frac{{\sum }_{i = 1}^{n} {h}^{′} ( d ( {x}_{0} , {x}_{i} ) ) / n {\sum }_{i = 1}^{n} {w}_{i} / n}{{( {\sum }_{i = 1}^{n} {w}_{i} / n )}^{2}} ) = 2 {C}_{4} \frac{{\sum }_{i = 1}^{n} {h}^{′} ( d ( {x}_{0} , {x}_{i} ) ) / n}{{\sum }_{i = 1}^{n} {w}_{i} / n}$$

where we use the fact that w′ᵢ(x)≤h′(d(x₀,xᵢ)), and equality holds if and only if is exactly on the direction of (yᵢ−x).

Then we consider the convergence of its empirical average to this expectation. We know as n→∞, Σᵢ₌₁ⁿ|h′(d(x₀,xᵢ))|/n→C₂ and Σᵢ₌₁ⁿwᵢ/n→C₁. Further wᵢ and 1/wᵢ are all bounded with finite second moment values. Thus we can apply Slutsky theorem, such that:

$${lim}_{c \to 0} \frac{f ( {x}_{0} + c ϵ ) - f ( {x}_{0} )}{c} \leq 2 {C}_{4} \frac{{\sum }_{i = 1}^{n} \vert {h}^{′} ( d ( {x}_{0} , {x}_{i} ) ) \vert / n}{{\sum }_{i = 1}^{n} {w}_{i} / n} {\to }^{P} = 2 \frac{{C}_{4} {C}_{2}}{{C}_{1}}$$

showing that for any δ>0, we can choose sufficient large N, such that n is also sufficient large and satisfying:

$${lim}_{c \to 0} \frac{f ( {x}_{0} + cϵ ) - f ( {x}_{0} )}{c} - \frac{2 {C}_{4} {C}_{2}}{{C}_{1}} \leq δ$$

Then let's move on to discuss the updates of neighbors. We denote xᵢ for i=1, . . . , n−k are the points in both Bᵣ(x) and [symbol] ᵣ(x+ϵ). And we denote xᵢ for i=n−k+1, . . . , n as the points in Bᵣ(x) but not [symbol] ᵣ(x+ϵ). And we denote x^{new}ᵢ for i=1, . . . , k⁰ as the points in [symbol] ᵣ(x+ϵ) but not in Bᵣ(x). We use wᵢ to denote the weight if we consider x, and wᵢ as the one consider x+.

Then integrating the effect of updating neighbors and updating weights, the embedding change can be bounded as:

$$\begin{matrix}Δ f \text{(} \text{x} \text{)} = ( \frac{{\sum }_{i = 1}^{n} {w}_{i} {y}_{i} }{{\sum }_{i = 1}^{n} {w}_{i}} - \frac{{\sum }_{i = 1}^{n} {{w}_{i}}^{′} {y}_{i}^{′}}{{\sum }_{i = 1}^{n} {w}_{i}^{′}} ) + \\ ( \frac{{\sum }_{i = 1}^{n} {{w}_{i}}^{′} {y}_{i}^{′}}{{\sum }_{i = 1}^{n} {w}_{i}^{′}} - \frac{{\sum }_{i = 1}^{n - k} {{w}_{i}}^{′} {y}_{i}^{′} + {\sum }_{n = 1}^{{k}^{′}} {w}_{i}^{new} {y}_{i}^{new}}{{\sum }_{i = 1}^{n - k} {w}_{i}^{′} + {\sum }_{n = 1}^{{k}^{′}} {w}_{i}^{new}} ) \\ = ( A ) + ( B )\end{matrix}$$

(A) part is bounded by the previous gradient bound. And we will focus on bounding (B) part.

$$\begin{matrix}( B ) = ( \frac{{\sum }_{i = 1}^{n} {w}_{i}^{′} {y}_{i}^{′}}{{\sum }_{i = 1}^{n} {w}_{i}^{′}} - \frac{{\sum }_{i = 1}^{n} {w}_{i}^{′} {y}_{i}^{′}}{{\sum }_{i = 1}^{n - k} {w}_{i}^{′} + {\sum }_{n = 1}^{{k}^{′}} {w}_{i}^{new}} ) + \\ ( \frac{{\sum }_{i = 1}^{n} {w}_{i}^{′} {y}_{i}^{′}}{{\sum }_{i = 1}^{n - k} {w}_{i}^{′} + {\sum }_{n = 1}^{{k}^{′}} {w}_{i}^{new}} - \frac{{\sum }_{i = 1}^{n - k} {w}_{i}^{′} {y}_{i}^{′} + {\sum }_{n = 1}^{{k}^{′}} {w}_{i}^{new} {y}_{i}^{new}}{{\sum }_{i = 1}^{n - k} {w}_{i}^{′} + {\sum }_{n = 1}^{{k}^{′}} {w}_{i}^{new}} ) \\ = ( C ) + ( D )\end{matrix}$$

As ∥ϵ∥→0, we know all the updated neighbors have the smallest weights than those who remain the change, since d(xᵢ,x₀)→r and d(xⱼ,x₀)≤r as xᵢ is updated neighbors (in one of [symbol] ᵣ(x₀) or [symbol] ᵣ(x₀+ϵ) and xⱼ in both Bᵣ(x₀) and [symbol] ᵣ(x₀+ϵ). Combining with the result from assumption 1 and Lemma 1, we know for sufficient small large n, we have

$$\frac{k + {k}^{′}}{n} \leq {C}_{3} ϵ$$

in our case. Denote

$$k = \frac{- {\sum }_{i = n - k + 1}^{n} {{w}_{i}}^{′} + {\sum }_{i = 1}^{{k}^{′}} {w}_{i}^{new}}{{\sum }_{i}^{n} {w}_{i}^{′}}$$

We know k≤C₃ϵ. Therefore We know

$$\vert \frac{\frac{= 1}{- {\sum }_{i = n - k + 1}^{n} {w}_{i}^{′} + {\sum }_{i = 1}^{{k}^{′}} {w}_{i}^{new}}}{{\sum }_{i = 1}^{n - k} {w}_{i}^{′} + {\sum }_{i = 1}^{{k}^{′}} {w}_{i}^{new}} \vert = \vert \frac{- {\sum }_{i = n - k + 1}^{n} {w}_{i}^{′} + {\sum }_{i = 1}^{{k}^{′}} {w}_{i}^{new}}{{\sum }_{i = 1}^{n} {w}_{i}^{′} - {\sum }_{i = n - k + 1}^{n} {w}_{i}^{′} + {\sum }_{i = 1}^{{k}^{′}} {w}_{i}^{new}} \vert = \frac{k}{1 + k} \leq \frac{{C}_{3} ϵ}{1 - {C}_{3} ϵ}$$

We further derive the bound for (C):

$$( C ) = \frac{{\sum }_{i = 1}^{n} {w}_{i}^{′} {y}_{i}}{{\sum }_{i = 1}^{n} {w}_{i}^{′}} ( 1 - \frac{{\sum }_{i = 1}^{n} {w}_{i}^{′}}{{\sum }_{i = 1}^{n - k} {w}_{i}^{′} + {\sum }_{i = 1}^{{k}^{′}} {w}_{i}^{new}} ) = \frac{{\sum }_{i = 1}^{n} {w}_{i}^{′} {y}_{i}}{{\sum }_{i = 1}^{n} {w}_{i}^{′}} \frac{- {\sum }_{i = n - k + 1}^{n} {w}_{i}^{′} + {\sum }_{i = 1}^{{k}^{′}} {w}_{i}^{new}}{{\sum }_{i = 1}^{n - k} {w}_{i}^{′} + {\sum }_{i = 1}^{{k}^{′}} {w}_{i}^{new}} = f ( x ) \frac{- {\sum }_{i = n - k + 1}^{n} {w}_{i}^{′} + {\sum }_{i = 1}^{{k}^{′}} {w}_{i}^{new}}{{\sum }_{i = 1}^{n - k} {w}_{i}^{′} + {\sum }_{i = 1}^{{k}^{′}} {w}_{i}^{new}}$$

Therefore as ∥ϵ∥₂→0, we have

$${ }_{{‖ ϵ ‖}_{2} \to 0} ‖ \frac{( C )}{ϵ} ‖ \leq {C}_{3} {C}_{5}$$

lim. Similarly, we can bound

$${lim}_{{‖ ϵ ‖}_{2} \to 0} ( D ) :$$

$${lim}_{{‖ ϵ ‖}_{2} \to 0} ‖ \frac{( D )}{ϵ} ‖ 2 = {‖ \frac{- {\sum }_{i = n - k + 1}^{n} {w}_{i}^{′} {y}_{i}^{′} + {\sum }_{i = 1}^{{k}^{′}} {w}_{i}^{new} {y}_{i}^{new}}{( {\sum }_{i = 1}^{n - k} {w}_{i}^{′} + {\sum }_{i = 1}^{{k}^{′}} {w}_{i}^{new} ) ϵ} ‖}_{2} \leq {C}_{4} \frac{- {\sum }_{i = n - k + 1}^{n} {w}_{i}^{′} + {\sum }_{i = 1}^{{k}^{′}} {w}_{i}^{new}}{( {\sum }_{i = 1}^{n - k} {w}_{i}^{′} + {\sum }_{i = 1}^{{k}^{′}} {w}_{i}^{new} ) ϵ} \leq {C}_{3} {C}_{4}$$

And we also have the gradient bound for f(x). Therefore we conclude that:

$${lim}_{{‖ ϵ ‖}_{2} \to 0} {‖ \frac{f ( x + ϵ ) - f ( x )}{ϵ} ‖}_{2} \leq {lim}_{{‖ ϵ ‖}_{2} \to 0} ( {‖ \frac{( C ) + ( D )}{ϵ} ‖}_{2} + \frac{2 {C}_{4} C2}{{C}_{1}} + δ ) \leq {C}_{3} {C}_{4} + {C}_{3} {C}_{4} + \frac{2 {C}_{4} {C}_{2}}{{C}_{1}} + δ = 2 {C}_{4} ( \frac{{C}_{2}}{{C}_{1}} + {C}_{3} ) + δ$$

The second inequality holds for our derived bound of (C) and (D).

After deriving the Lipschitz upper bound of neighborhood preserving layer, we compare it with the lipschitz bound of fully-connected layer. We know when only one layer is considered, give X∈R^{n*p} and y∈R^{n*d}, the best fully connected layer is equivalent to a multi-response regression problem. Denoting W=(w⁽¹⁾, . . . , w^{(d)}), we have:

w₍ᵢ₎=(X_{T}X)₋₁X_{T}yᵢ

This choice of weights can minimize the ′₂ loss in this specific layer, and is the best unbiased linear weight. When single layer is considered, this is the target weights we should use. To proceed the analysis, we introduce a set of regularity condition for x and y.

ASSUMPTION 3. We assume yᵢ's are independently sampled from distribution Q in ball B_{C}_{₄}(0) and symmetric over center 0, and xᵢ's are independently distributed from P such that E(x)=0 and cov(x). C₅/ₚ.

The assumption requires the distribution of low dimensional embedding y is well behaved, and covariance matrix has eigenvalue upper bound. It holds naturally as long as x is bounded. Further we assume each x⁽ⁱ⁾ and yⱼ are has correlation rᵢⱼ. All these assumptions can also be easily achieved by our neighborhood preserving layer.

THEOREM 2. When above assumptions 3 holds, for arbitrary constant δ>0, such that we have the previously defined weight W satisfies:

$${‖ {w}^{( j )} ‖}_{2} \geq \frac{1}{{C}_{5}} \sqrt{{\sum }_{i = 1}^{p} {C}_{i}^{2} {r}_{i}^{2}} - δ$$

And further the Lipschitz constant of this fully connected layer satisfies that there exist direction of with ∥∈∥₂ such that:

$${lim}_{c \to 0} {‖ \frac{f ( {x}_{0} + cϵ ) - f ( {x}_{0} )}{c} ‖}_{2} \geq \frac{1}{{C}_{5}} \sqrt{{\sum }_{i = 1}^{p} {C}_{i}^{2} {r}_{i}^{2}} - δ$$

where Cᵢ=sd(x^{(j)})sd(yᵢ), is the product of two standard deviations.

Remark: Since the fully connected layers are designed to extract feature of x and pass to y, therefore rᵢ should be large.

Proof. As we have shown, we know w⁽ⁱ⁾=(X^{T}X)⁻¹X^{T}yᵢ. Thus we have

∥w⁽ⁱ⁾∥₂=∥(X^{T}X)⁻¹X^{T}yᵢ∥₂

By the covariance bounded eigenvalue assumption, we know

$${{ }_{n \to x}}^{\frac{1}{n} {X}^{T} X}$$

lim C₅Iₚ. Thus we can find sufficient large n, such that

$$\frac{1}{n} {X}^{T} X ≲ ( {C}_{5} + δ ) I .$$

Further we write X^{T}yᵢ=(X⁽¹⁾^{_{T}}yᵢ, . . . , X^{(p)}^{_{T}}yᵢ)∈R^{p}, and derive:

$${‖ {( {X}^{T} X )}^{- 1} {X}^{T} {y}_{i} ‖}_{2} \geq \frac{1}{( {C}_{5} + δ ) n} {‖ {X}^{T} {y}_{i} ‖}_{2} \geq \frac{1}{{C}_{5} + δ} \sqrt{{\sum }_{i = 1}^{p} {( {cov}_{n} ( {X}^{( i )} , {y}_{i} ) )}^{2}}$$

And we know:

$${lim}_{n -> ∞} {cov}_{n} ( {X}^{( i )} , {y}_{i} ) -> cov ( {x}^{( i )} , {y}_{i} ) = cor ( {x}^{( i )} , {y}_{i} ) sd ( {x}^{( i )} ) sd ( {y}_{i} ) = {C}_{i} {r}_{i}$$

where Cᵢ=sd(x⁽ⁱ⁾)sd(yᵢ). Substituting into previous equation, for any δ>0, we can find sufficient large n such that:

$${‖ W ‖}_{2} \geq {‖ {w}^{( i )} ‖}_{2} \geq \frac{1}{{C}_{5} + δ} \sqrt{{\sum }_{i = 1}^{p} {C}_{i}^{2} {r}_{i}^{2}} - δ$$

Finally, the lipschitz constant satisfies:

$${lim}_{{‖ ϵ ‖}_{2} -> 0} {‖ \frac{f ( {x}_{0} + ϵ ) - f ( {x}_{0} )}{ϵ} ‖}_{2} \geq {sup}_{x ∈ {ℝ}^{p}} \frac{{‖ {w}^{( i )} x ‖}_{2}}{{‖ x ‖}_{2}} = {‖ {w}^{( i )} ‖}_{2} \geq \frac{1}{{C}_{5} + δ} \sqrt{{\sum }_{i = 1}^{p} {C}_{i}^{2} {r}_{i}^{2}} - δ$$

So far we have derived the Lipschitz upper bound of our neighborhood preserving layer:

$${T}_{1} = 2 {C}_{4} ( \frac{{C}_{2}}{{C}_{1}} + {C}_{3} ) + δ ,$$

and the lower bound of the fully connected regression layer:

$${T}_{2} = \frac{1}{{C}_{5} + δ} √ {\sum }_{i = 1}^{p} {C}_{i}^{2} {r}_{i}^{2} - δ .$$

And we see

$$\frac{{T}_{1}}{{T}_{2}} = o ( 1 / p )$$

when all rᵢ are O(1). It means in general our neighborhood layer are on the o(1/p) order of Lipschitz bound of designed fully connected layer.

The derived Lipschitz bound is closely related to the robustness of the network, and also the gradient descent based attack method. If the Lipschitz constant is small overall, then perturbs from all directions cannot significantly change the loss function, thus the gradient descent based attack will be ineffective.

To illustrate this effect, first we need to introduce ‘minimal Lₚ distortion’, which is a well acknowledged metric for robustness evaluation. (Hein and Andriushchenko 2017)

DEFINITION 1. We say a network has minimal Lₚ distortion δₚ at point x, if δₚ is defined as:

$${min}_{δ ∈ {ℝ}^{d}} {‖ δ ‖}_{p} s . t . {max}_{l \neq c} {f}_{l} ( x + δ ) \geq {f}_{c} ( x + δ ) and x ∈ C$$

where δₚ is the maximal distortion Lₚ norm allowed such that all distortion smaller than this magnitude will not change the classification label. This metric is closely related to the performance of a network against C&W attack. In C&W attack, we exactly look for a L₂ distortion in S such that maximize the difference in loss function.

COROLLARY 1. If condition in Theorem 1 and 2 holds, then the minimal L2 distortion bound introduced in Hein and Andriushchenko. (2017) will be improved by T₂/T₁ times by replacing fully-connected layer with UMAP layer.

Proof. If we assume the Lipschitz constant previous to the dimension reduction layer is Lₐ, and after the dimension reduction layer is L_{b}. Then as analyzed in Szegedy et al. (2013), the lipschitz constant of the whole network with UMAP layer is L=LₐL_{b}T₁, and for network with fully-connected layer is L=LₐL_{b}T₂. Then we plug the Lipschitz bound into Theorem 2.1 in Hein and Andriushchenko. (2017), choosing p=q=2 and radius to be sufficient large, then we know that:

$$‖ δ ‖ \leq \{ {min}_{j \neq c} \frac{{f}_{c} ( x ) - {f}_{j} ( x )}{L} \}$$

Thus we obtain that the minimal L₂ distortion bound:

$${δ}_{umap} = \frac{{T}_{2}}{{T}_{1}} {δ}_{fc}$$

So far, we have analyzed how UMAP layer help shrink the Lipschitz constant and thus help improve the minimal distortion bound. Madry et al. (2017) propose the saddle point problem, and well recognized as a good measure of the robustness of the network:

ρ=E_{x,y}[maxL(θ,x+δ,y)]_{δ∈S}

where S is the feasible region of a small distortion with radius.

Then the distortion can be evaluated as:

$${g}_{δ} = {𝔼}_{x , y} [ {max}_{δ ∈ S} L ( θ , x + δ , y ) ] - {𝔼}_{x , y} [ L ( θ , x , y ) ]$$

Here we show that taking advantage of the result from Theorem 1, our robustness will also be significantly improved under this metric.

THEOREM 3. If all conditions in Theorem 1 are satisfied. And the loss function for classification is chosen as negative log likelihood loss. The network with bottleneck has distortion expectation upper bound:

$${g}_{δ} \leq {L}_{a} ϵ \int {max}_{δ ∈ S} Lip ( f ( z + {L}_{a} δ ) ) dz$$

where Lip(·) is the lipschitz constant for specific value as defined. Further we know under Assumption 1-3, the distortion bound of fully-connected layer is

$$\frac{{T}_{2}}{{T}_{1}}$$

times of our neighborhood preserving layer.

Proof. First we know the negative log likelihood loss is additive over the final values of all layers. Therefore here we just need to derive the bound for each class output, we denote them as hᵢ(θ,z,y) for i=1, . . . , c, treating z layer as the input of the function. And we denote z=f(x) to represent all layers ahead of the dimension reduction layer.

Then by definition, we have:

$$\begin{matrix}{g}_{δ} = {𝔼}_{x , y} [ {max}_{δ ∈ S} h ( θ , f ( x + δ ) , y ) ] - {𝔼}_{x , y} [ h ( θ , f ( x ) , y ) ] \leq \\ {𝔼}_{z , y} [ {max}_{δ ∈ S} h ( θ , z + {L}_{a} δ , y ) ] - {𝔼}_{x , y} [ h ( θ , f ( x ) , y ) ] \\ = \int {max}_{δ ∈ S} ( h ( θ , z + {L}_{a} δ , y ) - h ( θ , z , y ) ) dz \leq \\ {L}_{a} ϵ \int {max}_{δ ∈ S} Lip ( f ( z + {L}_{a} δ ) ) dz\end{matrix}$$

where Lip(·) is the lipschitz constant for specific value as defined. Thus maxLip(f(z)+_{δ∈S}δ) term varies. We don't further bound this term since it varies from points to points, and can be specified in different settings. But as stated, the distortion bound is proportion to its Lipschitz constant bound. In our case, it is

$$\frac{{T}_{2}}{{T}_{1}} .$$

We can see that in aspect of saddle point problem, the distortion is also proportion to the Lipschitz bound.

Adversarial Training with Exemplars

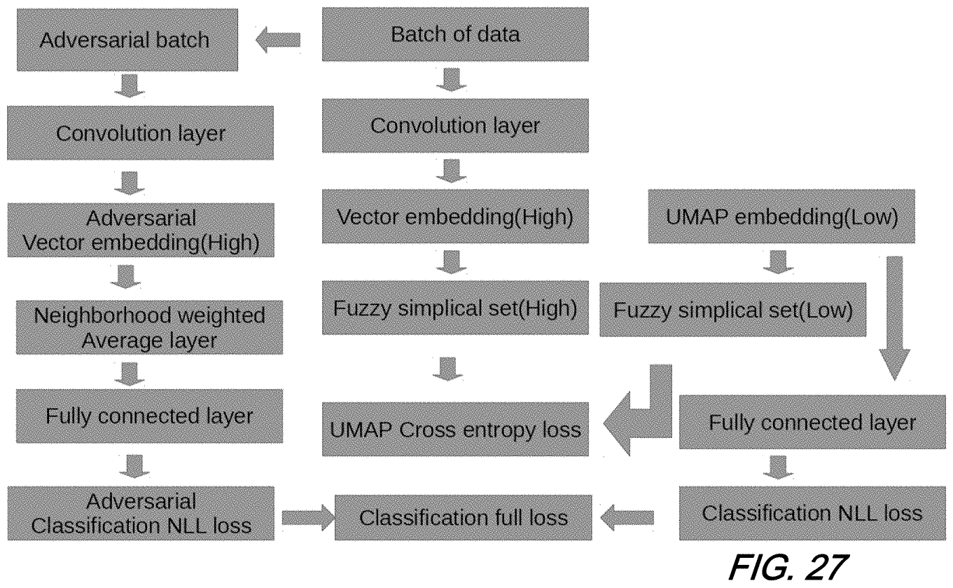

Here we consider how to achieve adversarial training in our framework. In each batch, we calculate loss both the true data, and a generated ‘adversarial batch’. The adversarial batch is generated using PGD attack algorithm. The adversarial training framework can be summarized in FIG. 27—which is a schematic block diagram outlining our adversarial attack framework according to aspects of the present disclosure.

In previous framework, we need the high-dimensional embedding and lowdimensional embedding of all training data points to calculate the neighbors and low-dimensional embedding of coming unseen points. It requires lots of memory to calculate the embedding, and it is not realistic to calculate this neighborhood graph for each batch iteration. Therefore, we now consider using partial points(or exemplar) with proper weight, to calculate the neighborhood weighted average layer.

So far we have developed two. First, (1) we just use each batch as the exemplar itself. We just need to calculate its high-dimensional embedding, and, when the batch size is reasonable, it works well in experiment, achieving testing accuracy >97%. Second, (2) we assign high/low-dimensional embedding and corresponding weights with specific number of points. So far, we initialize them by using K-means clustering with 100 clusters for each class. For MNIST, we then have 1000 clusters with cluster centers xᵢ and yᵢ in high- and low-dimensions. Each cluster has weight wᵢ which is the size of the cluster. We found this approach maintain accuracy at 95%.

Experiment on Robust Attack

To evaluate the empirical robustness of our network, we implement gradient descent based attack on our trained network and standard CNN network with same network layer structure and size. The PGD attack is considered move the original data towards the direction with largest gradient:

xₜ₊₁=Π_{ϵ}{x^{t}+αsign(∇ₓ [symbol] (f(x^{t}),y₀))}

In our experiment, the Π is considered as ′_{∞} projection over the data. We normalize the data such that the data ranges from 0 to 1. Therefore ϵ=0.01 represents changes up to about 3 pixels, and ϵ=0.05 represents changes up to about 15 pixels, so on and so forth. In the table, ‘FC’ represents fully connected bottleneck network, ‘UMAP’ represents proposed UMAP bottleneck network, ‘Ref’ represents proposed UMAP bottleneck network with only 1000 reference point instead of full dataset. The subscription number means the dimensionality of the layer. We provide a table with ′₀ projection attack under different bottleneck layers:

TABLE 1
Accuracy result under [symbol] ₀ projection PGD attack

| Perturbation | FC₈ | FC₁₆ | UMAP₈ | UMAP₁₆ | Ref₈ | Ref₁₆ |
|---|---|---|---|---|---|---|
| ϵ = 0.01 | 98.56 | 98.98 | 96.85 | 96.95 | 94.42 | 94.52 |
| ϵ = 0.05 | 84.78 | 88.46 | 94.82 | 94.26 | 90.40 | 90.95 |
| ϵ = 0.1 | 37.82 | 46.13 | 91.67 | 90.72 | 81.76 | 89.69 |
| ϵ = 0.2 | 9.67 | 11.30 | 89.73 | 89.04 | 73.89 | 74.92 |

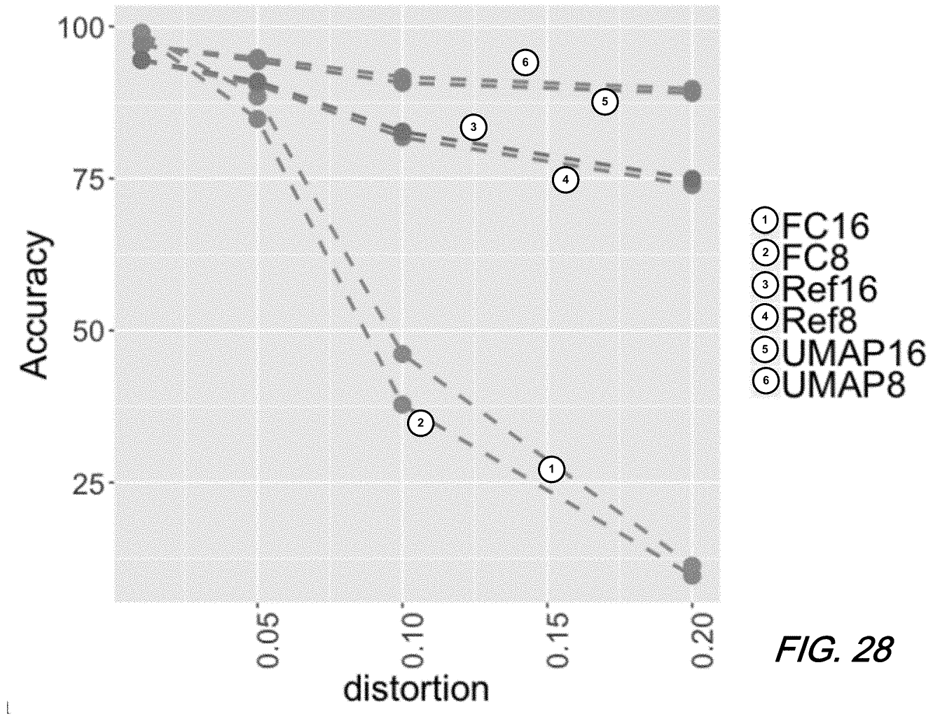

We also visualize that table in FIG. 28. From the result, we can see that when we use all training data as reference point, we achieve highest accuracy against different level of perturbation. When we use a relatively small number of reference points, the performance drops but still relatively robust.

At this point, while we have presented this disclosure using some specific examples, those skilled in the art will recognize that our teachings are not so limited. In particular, going forward we shall consider two issues: (1) How to effectively update a reference point without mapping it to the whole training data set; and (2) How to apply our approach in CIFAR10 dataset with VGG network. Accordingly, this disclosure should only be limited by the scope of the claims attached hereto.

1. A method of training a neural network, said method CHARACTERIZED BY:
gradient backpropagation of weighted-average neighbor layer is modified into input domain entries.

2. The method of claim 1 FURTHER CHARACTERIZED BY pre-input process (encoder) is learned along with input domain entries.

3. The method of claim 2 FURTHER CHARACTERIZED BY a fixed size embedding layer adapts to input domain distributions with unbounded training data.

4. The method of claim 3, FURTHER CHARACTERIZED BY data augmentation training or adversarial training of the neural network.

5. The method of claim 1 FURTHER CHARACTERIZED BY implicitly maintained input space entries for fixed size input dataset(s).

6. A method of training a neural network, said method CHARACTERIZED BY:
age-discounted neighbor weights adapting to time dependent input distribution(s).

7. The method of claim 6 FURTHER CHARACTERIZED BY a variable number of time-adaptive mapping entries applied to streaming data.

8. The method of claim 7 FURTHER CHARACTERIZED BY bound memory usage via merge operation.

9. The method of claim 6 FURTHER CHARACTERIZED BY gradient backpropagation of weighted average neighbor layer modified into input domain entries.

10. The method of claim 9 FURTHER CHARACTERIZED BY learning a neighbor embedding layer when a stream of inputs is applied having a time dependent input distribution.
